(19) United States
(12) Patent Application Publication
(10) Pub. No.: US 2011/0230359 A1
(43) Pub. Date: Sep. 22, 2011

(54) LABEL-FREE ON-TARGET PHARMACOLOGY METHODS

(76) Inventors: Ye Fang, Painted Post, NY (US); Ann MeeJin Ferrie, Painted Post, NY (US)

(21) Appl. No.: 13/048,488

(22) Filed: Mar. 15, 2011

Related U.S. Application Data
(60) Provisional application No. 61/315,653, filed on Mar. 19, 2010.

(51) Int. Cl. C40B 30/00; G06F 19/00

(52) U.S. Cl. 506/7; 702/19

(57) ABSTRACT

Disclosed are methods and machines to determine on-target pharmacology of molecules using label-free biosensor cellular assays and label-free biosensor integrative pharmacology.

### CLAIMING BENEFIT OF PRIOR FILED U.S. APPLICATION

This application claims the benefit of priority to U.S. Provisional Application No. 61/315,653, filed on Mar. 19, 2010, which is incorporated by reference here.

### CROSS-REFERENCE TO RELATED APPLICATION

U.S. Provisional Application No. 61/315,625 filed on Mar. 19, 2010 entitled METHODS FOR DETERMINING MOLECULAR PHARMACOLOGY USING LABEL-FREE INTEGRATIVE PHARMACOLOGY is hereby incorporated by reference in its entirety.

### BACKGROUND

The disclosure relates to biosensors, and more specifically to the use of such biosensors to characterize targets and molecules. The disclosure also relates to methods of determining on-target pharmacology of molecules and a method of drug discovery.

### SUMMARY

The disclosure provides methods, composition, articles, and machines for label-free on-target pharmacology approach, and performing systems biology and systems pharmacology analysis of molecules, as well as drug discovery. The disclosure also provides methods using multiple assay formats, in conjunction with label-free cellular integrative pharmacology approach, to determine the on-target pharmacology of molecules.

### BRIEF DESCRIPTION OF THE DRAWINGS

FIGS. 1A to 1H shows a representative example of how the disclosed methods can use the label-free on-target pharmacology approach to determine the on-target pharmacology of the β2 adrenergic receptor agonist salbutamol. The on-target pharmacology approach uses a panel of assay formats to generate a numerical description of drug pharmacology in terms of the label-free biosensor output signal.

FIG. 1A shows the DMR signal of quiescent A431 cells responding to the sustained stimulation with salbutamol. This is a sustained stimulation assay.

FIG. 1B shows the propranolol DMR signals of quiescent A431 cells, without (DMSO−propranolol) and with the pre-treatment with salbutamol (Salbutamol−propranolol). This is a sequential stimulation assay.

FIG. 1C shows the DMR signal of quiescent A431 cells responding to forskolin in the absence (Forskolin) and presence of salbutamol (Forskolin+salbutamol). This is a co-stimulation assay.

FIG. 1D shows the salbutamol DMR signal of the epinephrine-pretreated A431 cells. This is a reverse sequential stimulation assay wherein the cells are pre-stimulated with the endogenous agonist for the receptor.

FIG. 1E shows the salbutamol DMR signal of quiescent A431 cells pretreated without (DMSO−salbutamol) and with TBB (TBB−salbutamol). This is a sequential stimulation assay.

FIG. 1F shows the salbutamol DMR signal of A431 cells pretreated without (DMSO−salbutamol) and with pertussis toxin (PTX−salbutamol). Here the cells are preconditioned by overnight treatment with pertussis toxin.

FIG. 1G shows the epinephrine DMR signal of quiescent A431 cells without (DMSO−epinephrine) and with salbutamol (Salbutamol−epinephrine). This is a classical sequential antagonist assay wherein the cells are pre-exposed to a molecule, followed by stimulation with the endogenous β2AR agonist epinephrine.

FIG. 1H shows the salbutamol DMR modulation index in A431 cells against a panel of 4 markers: 2 nM epinephrine, 1 μM histamine, 32 nM epidermal growth factor, and 1 μM nicotinic acid. In all experiments showed in FIGS. 1A to 1H, the concentration of salbutamol was 10 μM.

FIG. 2 shows a heat map of the clusters of known adrenergic receptor drug molecules, according to the disclosed methods including the on-target pharmacology approach. The heat map was made using a one-dimension similarity analysis. For modulation percentage calculations, one or two DMR events for each marker-induced DMR signals were used. For other assays, an identical number matrix consisting of 5-time domain responses was used to describe the response of a molecule. The 5 time domain responses were the real values of a DMR signal at 3 min, 5 min, 9 min, 15 min and 50 min post stimulation. For β-adrenergic drugs, it is evident that a sub-cluster mostly consists of drug molecules having almost identical therapeutic indication.

### DETAILED DESCRIPTION

Various embodiments of the disclosure will be described in detail with reference to drawings, if any. Reference to various embodiments does not limit the scope of the disclosure, which is limited only by the scope of the claims attached hereto. Additionally, any examples set forth in this specification are not intended to be limiting and merely set forth some of the many possible embodiments for the claimed invention.

Label-free biosensor cellular assays generally use a label-free biosensor to detect cellular responses in a cell in response to stimulation. The resultant biosensor signal is typically an integrated response reflecting the complexity of molecular pharmacology acting on the cell. Traditionally, a label-free biosensor cellular assay directly monitors the kinetic response of a cell upon stimulation with a molecule, leading to a primary profile of the molecule acting on the cell. Alternatively, label-free biosensor cellular assays can also be use to examine the impact of the molecule on a marker-induced biosensor signal in a cell, leading to a secondary profile of the molecule against the marker-triggered pathways in the cell. The marker is a known molecule that is able to trigger a reproducible biosensor signal in the cell. The marker is often the endogenous agonists or activators for a receptor. These assays allow the pharmacological characterization of molecules in the context of target specificity, potency and efficacy, and mode of actions (i.e., agonism, or antagonism, or inverse agonism). In these assays, the pharmacological characterization is often done by analyzing the amplitude or kinetic parameters of a specific label-free event, such as a positive-DMR (P-DMR) or a negative-DMR(N-DMR) (see United States Patent Application No. 20090093011. Fang, Y. et al. Biosensors for ligand-directed functional selectivity). Although these assays allow the determination of ligand-directed functional selectivity of molecules acting through a receptor (such as β2-adrenergic receptor), these assays often suffer several limitations: (1) effective multi-parameter analysis requires high quality assay data, particularly kinetic fitting of a label-free biosensor profile can be extremely challenging due to lacking of the understanding of each biosensor event, and/or lacking of meaningful mathematic equations to describe each type of biosensor signals. (2) The resolution of ligand-directed functional selectivity determination is largely limited, since these assays are often limited to early signaling events, particularly these events which play a dominant role in the biosensor output signal obtained.

A label-free integrative pharmacology approach to characterize molecules is also available (see U.S. application Ser. No. 12/623,693. Fang, Y. et al. “Methods for Characterizing Molecules”, Filed Nov. 23, 2009; U.S. application Ser. No. 12/623,708. Fang, Y. et al. “Methods of creating an index”, filed Nov. 23, 2009). In this label-free integrative pharmacology approach, a label-free biosensor is used to determine the systems cell pharmacology of a drug candidate molecule by directly monitoring its actions on panels of different types of cells representative to human physiology and human pathophysiology, as well as to determine the ability of the drug candidate molecule to modulate the biosensor signals of each cell in response to stimulation, independently or collectively, with a panel of marker molecules. The direct action of a molecule on a cell leads to its primary profile, while the modulation of the molecule against a marker-induced biosensor signal results in a secondary profile. Both types of profiles are generally recorded as real time kinetic cellular responses. Comparing the primary profiles in the absence of a molecule with the secondary profiles in the presence of the molecule across multiple cells on which panels of markers act leads to panels of modulation profiles of the molecule against these markers. The entire or partial panels of profiles, for example, can be combined to produce an index. For example, the assembly of all primary profiles of a molecule acting on the panels of cells produces a molecule biosensor primary index, whereas the assembly of the modulation profiles of a molecule against the panels of markers acting on corresponding cells produces a molecule biosensor modulation index, and the combination of the molecule biosensor primary index with the molecule biosensor modulation index produces a molecule biosensor index. Comparing the molecule index with established indexes of panels of pharmacologically known modulators allows one to determine the cellular receptor(s) or target(s) or pathway(s) with which the molecule intervene(s). This label-free cellular integrative pharmacology approach provides information regarding to the polypharmacology and phenotypic pharmacology. However, this label free cellular integrative pharmacology also has limited resolution for determining the on-target pharmacology of molecules acting on a specific target.

Disclosed are methods of determining the on-target pharmacology of a molecule comprising the steps: a) collecting a biosensor response from a panel of assay formats; b) analyzing the biosensor response; and c) determining the on-target pharmacology of the molecule, or alone or in any combination with any method or step, article, composition, or machine disclosed herein.

Also disclosed are methods, wherein the biosensor response is a label-free biosensor response, wherein the panel consists of two to ten assay formats, wherein the assay formats are selected from a sustained agonism stimulation assay, an antagonism assay, a sequential stimulation assay, a reverse sequential stimulation assay, a co-stimulation assay, modulation assay, and a modulation profiling assay, wherein the assay formats are selected from a sustained agonism stimulation assay, a sequential antagonism stimulation assay, a reverse sequential stimulation assay, a co-stimulation with a pathway modulator, and modulation of a panel of markers for distinct pathways, wherein one or more of the assays collects data from a predetermined time domain, or alone or in any combination with any method or step, article, composition, or machine disclosed herein.

Also disclosed are methods, wherein there are 3-20, 3-15, 3-10, 3-7 or 3-5 time domain responses, wherein the time domain responses are taken 0-3 minutes, 3-6 minutes, 6-10 minutes, 10-20 minutes, 20-50 minutes and 50-120 minutes post-stimulation, wherein the time domain responses covers different waves of cell signaling, wherein the time domain responses are taken 3, 5, 9, 15 and 50 min post-stimulation, wherein analyzing the biosensor response comprises, numerically describing DMR signals, or alone or in any combination with any method or step, article, composition, or machine disclosed herein.

Also disclosed are methods, further comprising ordering the numerically described DMR signals into a number matrix, wherein the number matrix is produced by performing a clustering algorithm analysis, wherein the clustering algorithm analysis is one or two-dimensional, wherein the clustering algorithm is Hierarchical, K-means or MCL, wherein the clustering algorithm is Hierarchical, wherein the Hierarchical links groups using pairwise maximum linkage, wherein the clustering algorithm uses Euclidean distance for its distance metrics, wherein the clusters are viewed as a heat map, or alone or in any combination with any method or step, article, composition, or machine disclosed herein.

Also disclosed are methods of repositioning a test molecule comprising the steps: collecting biosensor responses of the test molecule from a panel of assay formats; analyzing the biosensor responses of the test molecule; determining the on-target pharmacology of the test molecule; clustering the drug molecule with existing drug molecules acting on the same target to identify the closest match in the on-target pharmacology of drug molecules; and repositioning the test molecule for the indication of the closest matched drug molecules.

### A. COMPOSITIONS, METHODS, ARTICLES, AND MACHINES

The pharmaceutical and biotech industries are challenged by seemingly opposing goals: (1) achieving lower attrition rates for new drugs and (2) reducing the introduction time of new drugs into the market. Drug discovery requires selecting an elusive molecule with desired pharmacological and physiological qualities out of a nearly unlimited number of chemical entities. Unfortunately, the selection of a drug can be an extremely costly and an intrinsically low efficiency process. Despite substantial investment in advanced technologies, the number of new drug approvals has remained low in the recent years. The current R&D productivity gap—the increasing amount of pharmaceutical R&D spending relative to the number of new drug candidates introduced per year—has generated widespread concern, and several divergent opinions about the problem and its potential solutions.

To exacerbate the situation, recent advances in genomics and proteomics have significantly increased the number of potential targets for new drugs. Target-oriented drug discovery techniques, despite previous successes against known targets, have often failed to deliver drugs against new targets (i.e. targets that are not the targets of previous drugs). Significantly, over the past decade, the entire industry has averaged only two to three small-molecule drugs against such “innovative” targets per year. As a result, many companies are reexamining the tools, techniques, and practices used in drug discovery and development. This introspection has highlighted the need for systems biology and systems pharmacology-based assessment and validation of drug actions, and for more physiologically relevant technologies, particularly in drug discovery.

1. Label-Free Biosensors

a) Biosensors and Biosensor Assays

Label-free cell-based assays generally employ a biosensor to monitor molecule-induced responses in living cells. The molecule can be naturally occurring or synthetic, and can be a purified or unpurified mixture. A biosensor typically utilizes a transducer such as an optical, electrical, calorimetric, acoustic, magnetic, or like transducer, to convert a molecular recognition event or a molecule-induced change in cells contacted with the biosensor into a quantifiable signal. These label-free biosensors can be used for molecular interaction analysis, which involves characterizing how molecular complexes form and disassociate over time, or for cellular response, which involves characterizing how cells respond to stimulation. The biosensors that are applicable to the present methods can include, for example, optical biosensor systems such as surface plasmon resonance (SPR) and resonant waveguide grating (RWG) biosensors, resonant mirrors, ellipsometers, and electric biosensor systems such as bioimpedance systems. Photonic crystal biosensor is a RWG biosensor.

(1) SPR Biosensors and Systems

SPR relies on a prism to direct a wedge of polarized light, covering a range of incident angles, into a planar glass substrate bearing an electrically conducting metallic film (e.g., gold) to excite surface plasmons. The resultant evanescent wave interacts with, and is absorbed by, free electron clouds in the gold layer, generating electron charge density waves (i.e., surface plasmons) and causing a reduction in the intensity of the reflected light. The resonance angle at which this intensity minimum occurs is a function of the refractive index of the solution close to the gold layer on the opposing face of the sensor surface

(2) RWG Biosensors and Systems

An RWG biosensor can include, for example, a substrate (e.g., glass), a waveguide thin film with an embedded grating or periodic structure, and a cell layer. The RWG biosensor utilizes the resonant coupling of light into a waveguide by means of a diffraction grating, leading to total internal reflection at the solution-surface interface, which in turn creates an electromagnetic field at the interface. This electromagnetic field is evanescent in nature, meaning that it decays exponentially from the sensor surface; the distance at which it decays to 1/e of its initial value is known as the penetration depth and is a function of the design of a particular RWG biosensor, but is typically on the order of about 200 nm. This type of biosensor exploits such evanescent wave to characterize ligand-induced alterations of a cell layer at or near the sensor surface.

RWG instruments can be subdivided into systems based on angle-shift or wavelength-shift measurements. In a wavelength-shift measurement, polarized light covering a range of incident wavelengths with a constant angle is used to illuminate the waveguide; light at specific wavelengths is coupled into and propagates along the waveguide. Alternatively, in angle-shift instruments, the sensor is illuminated with monochromatic light and the angle at which the light is resonantly coupled is measured.

The resonance conditions are influenced by the cell layer (e.g., cell confluency, adhesion and status), which is in direct contact with the surface of the biosensor. When a ligand or an analyte interacts with a cellular target (e.g., a GPCR, a kinase) in living cells, any change in local refractive index within the cell layer can be detected as a shift in resonant angle (or wavelength).

The Corning® Epic® system uses RWG biosensors for label-free biochemical or cell-based assays (Corning Inc., Corning, N.Y.). The Epic® System consists of an RWG plate reader and SBS (Society for Biomolecular Screening) standard microtiter plates. The detector system in the plate reader exploits integrated fiber optics to measure the shift in wavelength of the incident light, as a result of ligand-induced changes in the cells. A series of illumination-detection heads are arranged in a linear fashion, so that reflection spectra are collected simultaneously from each well within a column of a 384-well microplate. The whole plate is scanned so that each sensor can be addressed multiple times, and each column is addressed in sequence. The wavelengths of the incident light are collected and used for analysis. A temperature-controlling unit can be included in the instrument to minimize spurious shifts in the incident wavelength due to the temperature fluctuations. The measured response represents an averaged response of a population of cells. Varying features of the systems can be automated, such as sample loading, and can be multiplexed, such as with a 96 or 386 well microtiter plate. Liquid handling is carried out by either on-board liquid handler, or an external liquid handling accessory. Specifically, molecule solutions are directly added or pipetted into the wells of a cell assay plate having cells cultured in the bottom of each well. The cell assay plate contains certain volume of assay buffer solution covering the cells. A simple mixing step by pipetting up and down certain times can also be incorporated into the molecule addition step.

(3) Electrical Biosensors and Systems

Electrical biosensors consist of a substrate (e.g., plastic), an electrode, and a cell layer. In this electrical detection method, cells are cultured on small gold electrodes arrayed onto a substrate, and the system's electrical impedance is followed with time. The impedance is a measure of changes in the electrical conductivity of the cell layer. Typically, a small constant voltage at a fixed frequency or varied frequencies is applied to the electrode or electrode array, and the electrical current through the circuit is monitored over time. The ligand-induced change in electrical current provides a measure of cell response. Impedance measurement for whole cell sensing was first realized in 1984. Since then, impedance-based measurements have been applied to study a wide range of cellular events, including cell adhesion and spreading, cell micromotion, cell morphological changes, and cell death. Classical impedance systems suffer from high assay variability due to use of a small detection electrode and a large reference electrode. To overcome this variability, the latest generation of systems, such as the CellKey system (MDS Sciex, South San Francisco, Calif.) and RT-CES (ACEA Biosciences Inc., San Diego, Calif.), utilize an integrated circuit having a microelectrode array.

(4) High Spatial Resolution Biosensor Imaging Systems

Optical biosensor imaging systems, including SPR imaging systems, ellipsometry imaging systems, and RWG imaging systems, offer high spatial resolution, and can be used in embodiments of the disclosure. For example, SPR Imager®II (GWC Technologies Inc) uses prism-coupled SPR, and takes SPR measurements at a fixed angle of incidence, and collects the reflected light with a CCD camera. Changes on the surface are recorded as reflectivity changes. Thus, SPR imaging collects measurements for all elements of an array simultaneously.

A swept wavelength optical interrogation system based on RWG biosensor for imaging-based application may be employed. In this system, a fast tunable laser source is used to illuminate a sensor or an array of RWG biosensors in a microplate format. The sensor spectrum can be constructed by detecting the optical power reflected from the sensor as a function of time as the laser wavelength scans, and analysis of the measured data with computerized resonant wavelength interrogation modeling results in the construction of spatially resolved images of biosensors having immobilized receptors or a cell layer. The use of an image sensor naturally leads to an imaging based interrogation scheme. 2 dimensional label-free images can be obtained without moving parts.

Alternatively, angular interrogation system with transverse magnetic or p-polarized TM₀ mode can also be used. This system consists of a launch system for generating an array of light beams such that each illuminates a RWG sensor with a dimension of approximately 200 μm×3000 μm or 200 μm×2000 μm, and a CCD camera-based receive system for recording changes in the angles of the light beams reflected from these sensors. The arrayed light beams are obtained by means of a beam splitter in combination with diffractive optical lenses. This system allows up to 49 sensors (in a 7×7 well sensor array) to be simultaneously sampled at every 3 seconds, or up to the whole 384 well microplate to be simultaneously sampled at every 10 seconds.

Alternatively, a scanning wavelength interrogation system can also be used. In this system, a polarized light covering a range of incident wavelengths with a constant angle is used to illuminate and scan across a waveguide grating biosensor, and the reflected light at each location can be recorded simultaneously. Through scanning, a high resolution image across a biosensor can also be achieved

b) Biosensor Parameters

A label-free biosensor such as RWG biosensor or bioimpedance biosensor is able to follow in real time ligand-induced cellular response. The non-invasive and manipulation-free biosensor cellular assays do not require prior knowledge of cell signaling. The resultant biosensor signal contains high information relating to receptor signaling and ligand pharmacology. Multi-parameters can be extracted from the kinetic biosensor response of cells upon stimulation. These parameters include, but not limited to, the overall dynamics, phases, signal amplitudes, as well as kinetic parameters including the transition time from one phase to another, and the kinetics of each phase (see Fang, Y., and Ferrie, A. M. (2008) “label-free optical biosensor for ligand-directed functional selectivity acting on β2 adrenoceptor in living cells”. FEBS Lett. 582, 558-564; Fang, Y., et al., (2005) “Characteristics of dynamic mass redistribution of EGF receptor signaling in living cells measured with label free optical biosensors”. Anal. Chem., 77, 5720-5725; Fang, Y., et al., (2006) “Resonant waveguide grating biosensor for living cell sensing”. Biophys. J., 91, 1925-1940).

For clustering or similarity analysis, the edge attributes (i.e., biosensor cellular response data) for each node (i.e., a molecule) can be different. For example, for a molecule profile (primary secondary) in a cell, an edge attribute can be a specific kinetic parameter (e.g., the amplitude or kinetics of a DMR event in a DMR signal), or a real value of a biosensor signal at a given time post simulation, or real values of a biosensor signal at multiple or all time points post stimulation. For a molecule biosensor secondary profile an edge attribute can also be a modulation percentage of a biosensor signal output parameter against a specific marker after normalized to the respective marker primary profile. As a result, the collective edge attribute represents an effective means to display the label-free pharmacology of a node molecule, such that the similarity of the molecule to a known molecule can be compared and determined based on the disclosed methods.

c) DMR Parameters

(1) Biosensor Output Parameters

A number of different biosensor output parameters are discussed herein. For example, six parameters defining the kinetics of the stimulation-induced directional mass redistribution within the cells can be overall dynamics (i.e., shape), phases of the response (in the specific example of the EGF-induced DMR signal in quiescent A431 cells, there are three main phases relating to the cell response: Positive-Dynamic Mass Redistribution (P-DMR), Negative-Dynamic Mass Redistribution (N-DMR), and Recovery Positive-Dynamic Mass Redistribution (RP-DMR)), kinetics, total duration time of each phase, total amplitudes of each DMR event, and transition time from the P- to N-DMR phase, or from N-DMR to RP-DMR. Dynamic mass redistribution is often termed as dynamic cellular matter redistribution or directional mass redistribution. Other biosensor output parameters can be obtained from a resonant peak. For example, peak position, intensity, peak shape and peak width at half maximum (PWHM) can be used. Biosensor output parameters can also be obtained from the resonant band image of a biosensor. Five additional features: band shape, position, intensity, distribution and width. All of these parameters can be used independently or together for any given application of any cell assays using biosensors as disclosed herein. The use of the parameters in any subset or combination can produce a signature for a given assay or given variation on a particular assay, such as a signature for a cell receptor assay, and then a specific signature for an EGF receptor based assay.

(a) Parameters Related to the Kinetics of Stimulation-Induced Directional Mass Redistribution

There are a number of biosensor output parameters that are related to the kinetics of the stimulation-induced DMR. These parameters look at rates of change that occur to biosensor data output as a stimulatory event to the cell occurs. A stimulatory event is any event that may change the state of the cell, such as the addition of a molecule to the culture medium, the removal of a molecule from the culture medium, a change in temperature or a change in pH, or the introduction of radiation to the cell, for example. A stimulatory event can produce a stimulatory effect which is any effect, such as a directional mass redistribution, on a cell that is produced by a stimulatory event. The stimulatory event could be a molecule, a chemical, a biochemical, a biological, a polymer. The biochemical or biological could a peptide, a synthetic peptide or naturally occurring peptide. For example, many different peptides act as signaling molecules, including the proinflammatory peptide bradykinin, the protease enzyme thrombin, and the blood pressure regulating peptide angiotensin. While these three proteins are distinct in their sequence and physiology, and act through different cell surface receptors, they share in a common class of cell surface receptors called G-protein coupled receptors (GPCRs). Other polypeptide ligands of GPCRs include vasopressin, oxytocin, somatostatin, neuropeptide Y, GnRH, leutinizing hormone, follicle stimulating hormone, parathyroid hormone, orexins, urotensin II, endorphins, enkephalins, and many others. GPCRs belongs to a broad and diverse gene family that responds not only to peptide ligands but also small molecule neurotransmitters (acetylcholine, dopamine, serotonin and adrenaline), light, odorants, taste, lipids, nucleotides, and ions. The main signaling mechanism used by GPCRs is to interact with G-protein GTPase proteins coupled to downstream second messenger systems including intracellular calcium release and cAMP production. The intracellular signaling systems used by peptide GPCRs are similar to those used by all GPCRs, and are typically classified according to the G-protein they interact with and the second messenger system that is activated. For Gs-coupled GPCRs, activation of the G-protein Gs by receptor stimulates the downstream activation of adenylate cyclase and the production of cyclic AMP, while Gi-coupled receptors inhibit cAMP production. One of the key results of cAMP production is activation of protein kinase A. Gq-coupled receptors stimulate phospholipase C, releasing IP3 and diacylglycerol. IP3 binds to a receptor in the ER to cause the release of intracellular calcium, and the subsequent activation of protein kinase C, calmodulin-dependent pathways. In addition to these second messenger signaling systems for GPCRs, GPCR pathways exhibit crosstalk with other signaling pathways including tyrosine kinase growth factor receptors and map kinase pathways. Transactivation of either receptor tyrosine kinases like the EGF receptor or focal adhesion complexes can stimulate ras activation through the adaptor proteins She, Grb2 and Sos, and downstream Map kinases activating Erk1 and Erk2. Src kinases may also play an essential intermediary role in the activation of ras and map kinase pathways by GPCRs.”

It is possible that some stimulatory events can occur but there is no change in the data output. This situation is still a stimulatory event because the conditions of the cell have changed in some way that could have caused a directional mass redistribution or a change in the cell or cell culture.

It is understood that a particular signature can be determined for any assay or any cell condition as disclosed herein. There are numerous “signatures” disclosed herein for many different assays, but for any assay performed herein, the “signature” of that assay can be determined. It is also possible that there can be more than one “signatures” for any given assay and each can be determined as described herein. After collecting the biosensor output data and looking at one or more parameters, or the signature for the given assay can be obtained. It may be necessary to perform multiple experiments to identify the optimal signature and it may be necessary to perform the experiments under different conditions to find the optimal signature, but this can be done. It is understood that any of the method disclosed herein can have the step of “identifying” or “determining” or “providing”, for example, a signature added onto them.

(i) Overall Dynamics

One of the parameters that can be looked at is the overall dynamics of the data output. This overall dynamic parameter observes the complete kinetic picture of the data collection. One aspect of the overall dynamics that can be observed is a change in the shape of the curve produced by the data output over time. Thus the shape of the curve produced by the data output can either be changed or stay steady upon the occurrence of the stimulatory event. The direction of the changes indicates the overall mass distribution; for example, a positive-DMR (P-DMR) phase indicates the increased mass within the evanescent tail of the sensor; a net-zero DMR suggests that there is almost no net-change of mass within the evanescent tail of the sensor, whereas a negative-DMR indicates a net-deceased mass within the evanescent tail of the sensor.

The overall dynamics of a stimulation-induced cell response obtained using the optical biosensors can consist of a single phase (either P-DMR or N-DMR or net-zero-DMR), or two phases (e.g., the two phases could be any combinations of these three phases), or three phases, or multiple phases (e.g., more one P-DMR can be occurred during the time course).

(ii) Phases of the Response

Another parameter that can observed as a function of time are the phase changes that occur in the data output. A label free biosensor produces a data output that can be graphed which will produce a curve. This curve will have transition points, for example, where the data turns from an increasing state to a decreasing state or vice versa. These changes can be called phase transitions and the time at which they occur and the shape that they take can be used, for example, as a biosensor output parameter. For example, there can be a P-DMR, a net-zero DMR, a N-DMR, or a RP-DMR. The amplitude of the P-DMR, N-DMR, and the RP-DMR can be measured as separate biosensor output parameters.

(iii) Kinetics

Another biosensor output parameter can be the kinetics of any of the aspects of data output. For example, the rate at the completion of the phase transitions. For example, how fast the phase transition is completed or how long it does take to complete data output. Another example of the kinetics that can be measured would be the length of time for which an overall phase of the data output takes. Another example is the total duration of time of one or both of the P- and N-DMR phases. Another example is the rate or time in which it takes to acquire the total amplitudes of one or both of the P- and N-DMR phases. Another example can be the transition time τ from the P- to N-DMR phase. The kinetics of both P-DMR and N-DMR events or phases can also be measured.

(b) Parameters Related to the Resonant Peak

Resonant peaks of a given guided mode are a type of data output that occurs by looking at, for example, the intensity of the light vs. the angle of coupling of the light into the biosensor or the intensity of the light versus the wavelength of coupled light into the biosensor. The optical waveguide lightmode spectrum is a type of data output that occurs by looking at the intensity of the light vs. the angle of coupling of the light into the biosensor in a way that uses a broad range of angles of light to illuminate the biosensor and monitors the intensity of incoupled intensity as a function of the angle. In this spectrum, multiple resonant peaks of multiple guided modes are co-occurred. Since the principal behind the resonant peaks and OWLS spectra is the same, one can use the resonant peak of a given guided mode or OWLS spectra of multiple guided modes interchangeably, hi a biosensor, when either a particular wavelength of light occurs or when the light is produced such that it hits the biosensor at a particular angle, the light emitted from the light source becomes coupled into the biosensor and this coupling increases the signal that arises from the biosensor. This change in intensity as a function of coupling light angle or wavelength is called the resonant peak. Distinct given modes of the sensor can give rise to similar resonant peaks with different characteristics. There are a number of different parameters defining the resonant peak or resonant spectrum of a given mode that can be used related to this peak to assess DMR or cellular effects. A subset of these are discussed below.

(i) Peak Position

When the data output is graphed the peak of the resonance peak occurs, for example, at either a particular wavelength of light or at a particular angle of incidence for the light coupling into the biosensor. The angle or wavelength that this occurs at, the position, can change due to the mass redistribution or cellular event(s) in response to a stimulatory event. For example, in the presence of a potential growth factor for a particular receptor, such as the EGF receptor, the position of the resonant peak for the cultured cells can either increase or decrease the angle of coupling or the wavelength of coupling which will result in a change in the central position of the resonant peak. It is understood that the position of the peak intensity can be measured, and is a good point to measure, the position of any point along the resonant peak can also be measured, such as the position at 75% peak intensity or 50% peak intensity or 25% peak intensity, or 66% peak intensity or 45% peak intensity, for example (all levels from 1-100% of peak intensity are considered disclosed). However, when one uses a point other than the peak intensity, there will always be a position before the peak intensity and a position after the peak intensity that will be at, for example, 45% peak intensity. Thus, for any intensity, other than peak intensity, there will always be two positions within the peak where that intensity will occur. The position of these non-peak intensities can be utilized as biosensor output parameters, but one simply needs to know if the position of the intensity is a pre-peak intensity or a post-peak intensity.

(ii) Intensity

Just as the position of a particular intensity of a resonant peak can used as a biosensor output parameter, so to the amount of intensity itself can also be a biosensor output parameter. One particularly relevant intensity is the maximum intensity of the resonant peak of a given mode. This magnitude of the maximum intensity, just like the position, can change based on the presence of a stimulatory event that has a particular effect on the cell or cell culture and this change can be measured and used a signature. Just as with the resonant peak position, the resonant peak intensity can also be measured at any intensity or position within the peak. For example, one could use as a biosensor output parameter, an intensity that is 50% of maximum intensity or 30% of maximum intensity or 70% of maximum intensity or any percent between 1% and 100% of maximum intensity. Likewise, as with the position of the intensity, if an intensity other than the maximum intensity will be used, such as 45% maximum intensity, there will always be two positions within the resonant peak that have this intensity. Just as with the intensity position parameter, using a non-maximum intensity can be done, one just must account for whether the intensity is a pre-maximum intensity or a post-maximum intensity.

For example, the presence of both inhibitors and activators results in the decrease in the peak width at half maximum (PWHM) after culture when the original cell confluency is around 50% (at −50% confluency, the cells on the sensor surface tend to lead to a maximum PWHM value); however, another biosensor output parameter, such as the total angular shift (i.e., the central position of the resonant peak) can be used to distinguish an inhibitors from an activators from a molecule having no effect at all. The PWHM is length of a line drawn between the points on a peak that are at half of the maximum intensity (height) of the peak, as exampled in FIG. 6B. The inhibitors, for example, of cell proliferation, tend to give rise to angular shift smaller than the shift for cells with no treatment at all, whereas the activators tend to give rise to a bigger angular shift, as compared to the sensors having cells without any treatment at all, when the cell densities on all sensors are essentially identical or approximately the same. The potency or ability of the molecules that either inhibit (as inhibitors) or stimulate (as activator) cell proliferation can be determined by their effect on the PWHM value, given that the concentration of all molecules are the same. A predetermined value of the PWHM changes can be used to filter out the inhibitors or activators, in combination with the changes of the central position of the resonant peak. Depending on the interrogation system used to detect the resonant peak of a given mode, the unit or value of the PWHM could be varied. For example, for an angular interrogation system, the unit can be degrees. The change in the PWHM of degrees could be 1 thousandths, 2 thousandths, 3 thousandths, 5 thousandths, 7 thousandths, or thousandths, for example.

(iii) Peak Shape

Another biosensor output parameter that can be used is the overall peak shape, or the shape of the peak “between or at certain intensities. For example, the shape of the peak at the half maximal peak intensity, or any other intensity (such as 30%, 40%, 70%, or 88%, or any percent between 20 and 100%) can be used as a biosensor output parameter. The shape can be characterized by the area of the peak either below or above a particular intensity. For example, at the half maximal peak intensity there is a point that is pre-peak intensity and a point that is post-peak intensity. A line can be drawn between these two points and the area above this line within the resonant peak or the area below the line within the resonant peak can be determined and become a biosensor output parameter. It is understood that the integrated area of a given peak can also be used to analyze the effect of molecules acting on cells.

Another shape related biosensor output parameter can be the width of the resonant peak for a particular peak intensity. For example, at the width of the resonant peak at the half maximal peak intensity (HMPW) can be determined by measuring the size of the line between the pre-peak intensity point on the resonant peak that is 50% of peak intensity and the point on the line that is post-peak which is at 50% peak intensity. This measurement can then be used as a biosensor output parameter. It is understood that the width of the resonant peak can be determined in this way for any intensity between 20 and 100% of peak intensity. (Examples of this can be seen through out the figures, such as FIG. 6B).

(c) Parameters Related to the Resonant Band Image of a Biosensor

To date, most optical biosensors monitor the binding of target molecules to the probe molecules immobilized on the sensor surface, or cell attachment or cell viability on the sensor surface one at a time. For the binding event or cell attachment or cell viability on multiple biosensors, researchers generally monitor these events in a time-sequential manner. Therefore, direct comparison among different sensors can be a challenge. Furthermore, these detection systems whether it is wavelength or angular interrogation utilize a laser light of a small spot (˜100-500 μm in diameter) to illuminate the sensor. The responses or resonant peaks represent an average of the cell responses from the illuminating area. For a 96 well biosensor microplate (e.g., Corning's Epic microplate), each RWG sensor is approximately 3×3 mm² and lies at the bottom of each well, whereas the sensor generally has a dimension of 1×1 mm² for a 384 well microplate format. Therefore, the responses obtained using the current sensor technology only represent a small portion of the sensor surface. Ideally, a detection system should not only allow one to simultaneously monitor the responses of live cells adherent on multiple biosensors, but also allow signal interrogation from relatively large area or multiple areas of each sensor.

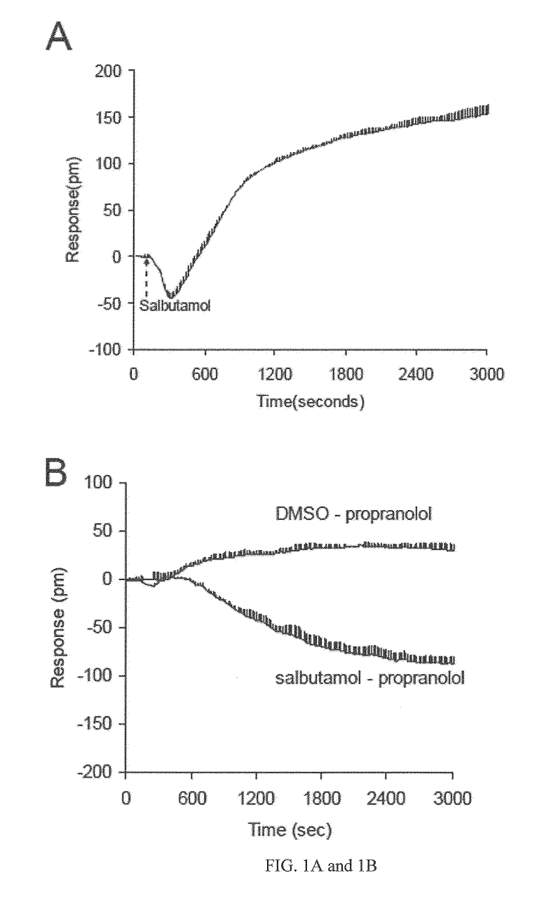

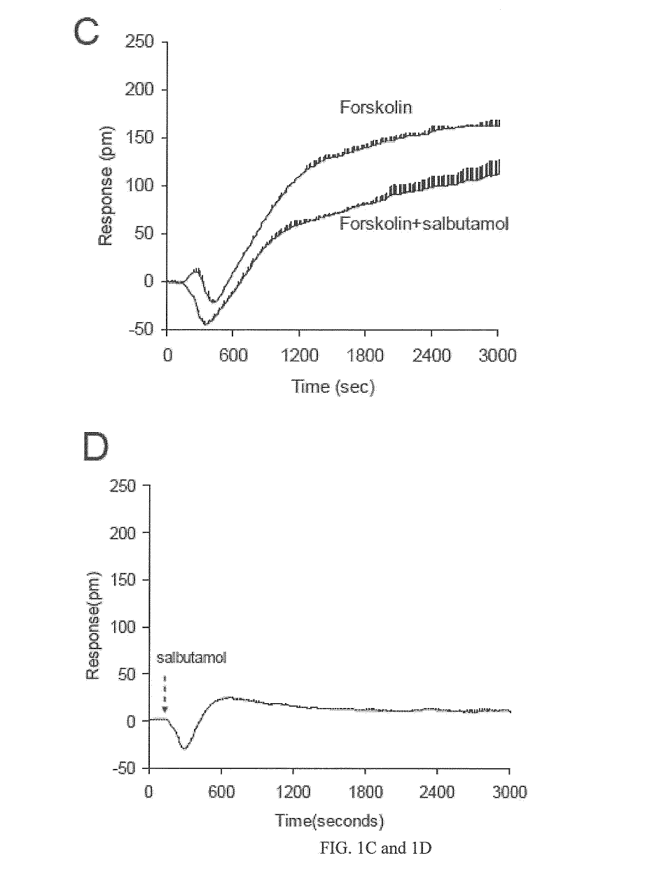

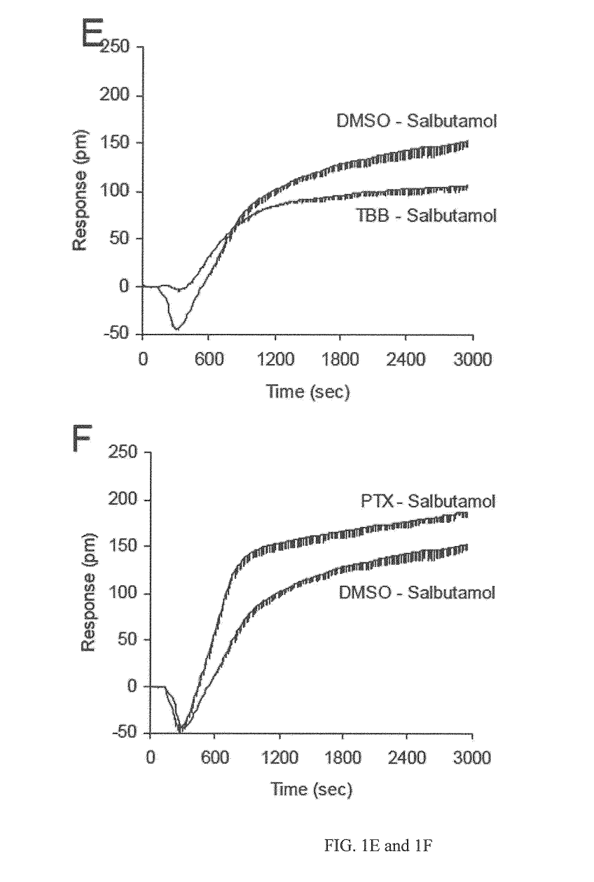

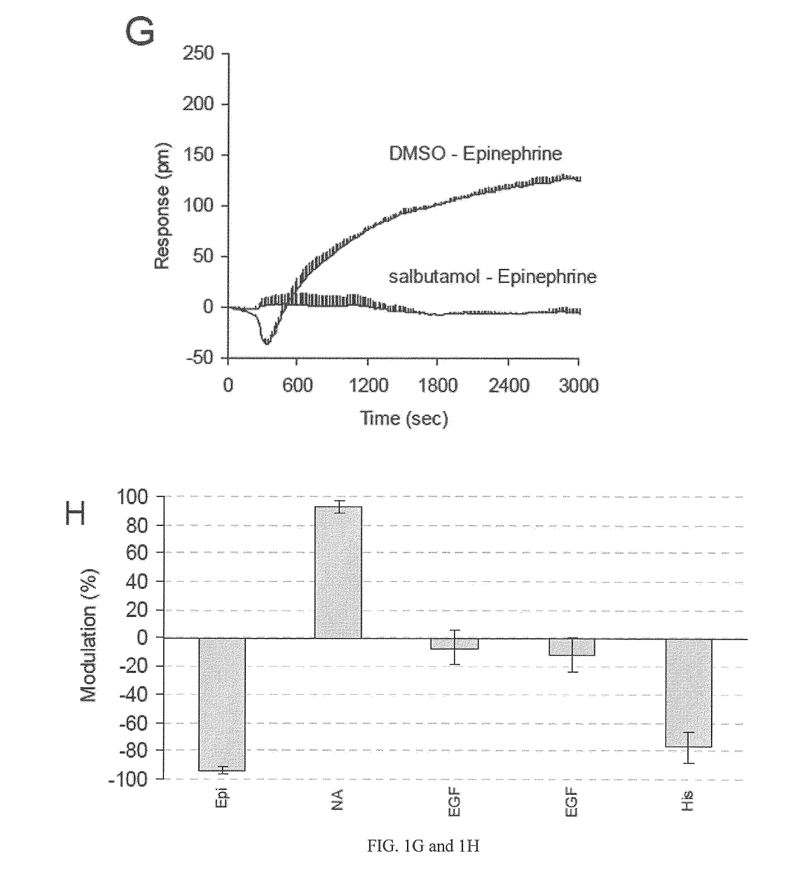

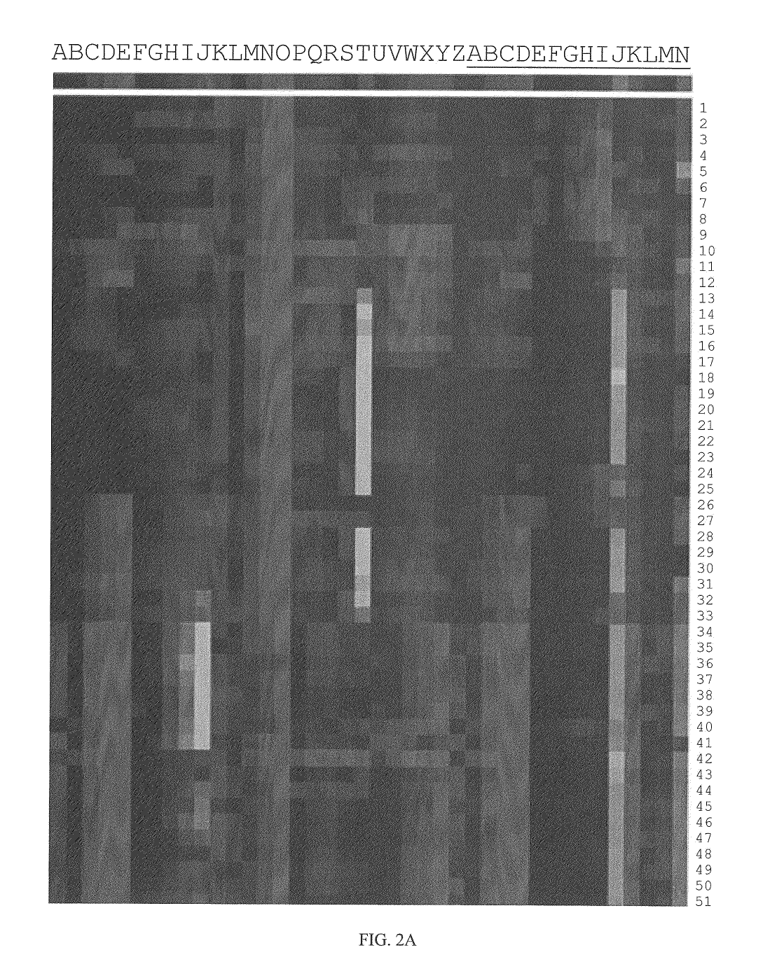

Resonant bands through an imaging optical interrogation system (e.g., a CCD camera) are a type of data output that occurs by looking at, for example, the intensity of the reflected (i.e., outcoupled) light at the defined location across a single sensor versus the physical position. Reflected light is directly related to incoupled light. Alternatively, a resonant band can be collected through a scanning interrogation system in a way that uses a small laser spot to illuminate the sensor, and scan across the whole sensor in one-dimension or two-dimension, and collect the resonant peak of a given guided mode. The resonant peaks or the light intensities as a function of position within the sensors can be finally reconsisted to form a resonant band of the sensor. In a biosensor, when either a particular wavelength of light occurs or when the light is produced such that it hits the biosensor at a particular angle, the outcoupled light varies as a function of the refractive index changes at/near the sensor surface and this changes lead to the shift of the characteristics of the resonant band of each sensor collected by the imaging system. Furthermore, the un-even attachment of the cells across the entire sensor after cultured can be directly visualized using the resonant band (See the circled resonant band in FIG. 1, for example). In an ideal multi-well biosensor microplate, the location of each sensor is relative to normalize to other biosensors; i.e., the sensors are aligned through the center of each well across the row or the column in the microplate. Therefore, the resonant band images obtained can be used as an internal reference regarding to the cell attachment or cellular changes in response to the stimulation. Therefore, such resonant band of each sensor of a given mode provides additional parameters that can be used related to this band to assess DMR or cellular effects. A subset of these are discussed below.

(i) Band Shape

Another biosensor output parameter that can be used is the shape of the resonant band of each biosensor of a given mode. The shape is defined by the intensity distribution across a large area of each sensor. The shape can be used as an indicator of the homogeneity of cells attached or cell changes in response to stimulation across the large area (for example, as shown in FIG. 1, each resonant band represents responses across the entire sensor with a dimension of ˜200 mm×3000 mm).

(ii) Position

Similar to the position of the resonant peak of each sensor of a given mode, the position of each resonant band can be used as a biosensor output parameter. The intensity can be quantified using imaging software to generate the center position with maximum intensity of each band. Such position can be used to examine the cellular changes in response to stimulation or molecule treatment.

(iii) Intensity

Just as the position of the resonant band, the intensity of the outcoupled light collected using the imaging system can be used as a biosensor output parameter. The average intensity of the entire band or absolute intensity of each pixel in the imaging band can be used to examine the quality of the cell attachment and evaluate the cellular response.

(iv) Distribution

The distribution of the outcoupled light with a defined angle or wavelength collected using the imaging system can be used as a biosensor output parameter. This parameter can be used to evaluate the surface properties of the sensor itself when no cells or probe molecules immobilized, and to examine the quality of cell attachment across the illuminated area of the sensor surface. Again, this parameter can also be used for examining the uniformity of molecule effect on the cells when the cell density across the entire area is identical; or for examining the effect of the cell density on the molecule-induced cellular responses when the cell density is distinct one region from others across the illuminated area.

(v) Width

Just like the PWHM of a resonant peak of a given mode, the width of the resonant band obtained using the imaging system can be used as a biosensor output parameter. This parameter shares almost identical features, thus the useful information content, to those of the PWHM value of a resonant peak, except that one can obtain multiple band widths at multiple regions of the illuminated area of the sensor, instead of only one PWHM that is available for a resonant peak. Similar to other parameters obtained by the resonant band images, the width can be used for the above mentioned applications.

All of these parameters can be used independently or together for any given application of any cell assays using biosensors as disclosed herein. The use of the parameters in any subset or combination can produce a signature for a given assay or given variation on a particular assay, such as a signature for a cell receptor assay, and then a specific signature for an EGF receptor based assay.

### B. METHODS

1. Method for Determining On-target Pharmacology

Disclosed herein are methods determining the on-target pharmacology of molecules. The label-free on-target pharmacology approach relates to label-free cellular assays and label-free integrative pharmacology. Disclosed herein are methods of using multiple assay formats, in conjunction with label-free cellular integrative pharmacology approaches, to determine the on-target pharmacology of molecules with higher resolution.

The approach overcomes limitations in both resolution and measurable cellular events of conventional label-free cellular assays and label-free integrative pharmacology. Thus, the methods described herein provide high resolution characterization of molecular on-target pharmacology. Conventional label-free cellular assays mostly examine the biosensor cellular response upon stimulation with a molecule, and/or determine the effect of a molecule on the biosensor cellular response mediated through a specific receptor (such as a G protein-coupled receptors (GPCRs), receptor tyrosine kinases (RTKs), etc). These assays individually or collectively investigate molecular pharmacology. However, label-free cellular assays are non-specific in nature and offer an integrated cellular response. Furthermore, label-free cellular assays are biased toward the biosensor output signal, i.e., for optical biosensors they are biased towards dynamic mass redistribution (DMR), while electric biosensors are biased towards ionic redistribution. Also, conventional label-free cellular assays are mostly used to monitor early cell signaling events. It is known that receptor activation leads to sophisticated signaling network interactions that often consist of thousands of cellular targets, many of which do not contribute to the biosensor signals obtained. Also, many cellular events or processes occur slowly. Thus, it is impossible to fully comprehend the on-target pharmacology of molecules using conventional label-free cellular assays.

In some embodiments, the methods use a panel of biosensor cellular responses at specific and predetermined time domains to numerically describe the label-free pharmacology of molecules.

In some embodiments, the methods use a similarity clustering or a clustering analysis approach to classify the molecules in terms of their label-free cellular integrative pharmacology or classify the pharmacology of molecules. In some embodiments, the clustering analysis enables linking in vitro label-free integrative pharmacology of molecules with in vivo pharmacology, thus enabling drug repositioning and novel drug combinations.

Using existing adrenergic receptor drugs as models showed that label-free cellular integrative pharmacology is directly correlated with their respective in-vivo indication(s).

In some embodiments, the molecules can target G protein-coupled receptors and receptor tyrosine kinases. The disclosed methods relate to label-free cellular assays and label-free cellular integrative pharmacology. Disclosed herein are methods using a panel of assay formats to determine important aspects of molecular pharmacology acting through a specific target. In some embodiments, the assay formats can be, but are not limited to, sustained agonism stimulation, sequential antagonism stimulation, reverse sequential stimulation, co-stimulation with a pathway modulator, and modulation of a panel of markers for distinct pathways. In some embodiments, the methods determine the on-target pharmacology of molecules using a numerical number matrix describing the label-free integrative pharmacology of molecules.

In some embodiments, the methods identify receptor drug molecules.

2. Assay Formats

Disclosed herein are methods using a panel of assay formats to characterize the on-target pharmacology.

a) Sustained Agonism Stimulation Assay

The sustained agonism stimulation assay or like terms refers to assaying cellular responses upon stimulation only with a molecule, wherein the molecule is brought to contact with the cells by simply adding a solution containing the molecule into the buffer solution covering the cells using conventional liquid handling techniques, such as pippetting, without subsequent removal of the molecule. In this assay, the cells are exposed to the molecule at all time, creating a sustained stimulation condition. An example of a sustained agonism stimulation assay is shown in FIG. 1A, wherein the A431 cells are exposed to salbutamol all the time post stimulation.

b) Antagonism Assay

The antagonism assay or like terms refers to a two-step assay, wherein a cell is first exposed to a molecule, followed by stimulation with a receptor agonist. The receptor agonist can be the endogenous agonist for the receptor of interest. The two steps are often separated by a specific period of time (e.g., 10 min, 30 min, 60 min, 90 min, 2 hrs, 5 hrs, or 1 day). For label-free cellular assays, the separation time between the two stimulation is mostly often to be ˜1 hr. This assay determines the ability of the molecule to modulate, or antagonize, or potentiate the agonist-induced biosensor signal. This assay is a specific example of sequential stimulation assays. An example is shown in FIG. 1G, wherein the A431 cells are first stimulated with salbutamol, followed by stimulation with the β2AR agonist epinephrine. In FIG. 1G, the two steps are separated by ˜60 min, only the second step is monitored, and salbutamol was presented all the time during both steps.

c) Sequential Stimulation Assay

The sequential stimulation assay or like terms refers to a two-step assay, wherein a cell is first exposed to a molecule, followed by stimulation with a referencing molecule. The referencing molecule can be an agonist, an antagonist, or an inverse agonist for the receptor. An example is shown in FIG. 1B, wherein the referencing molecule is the β2-AR inverse agonist propranolol. The inverse agonism of propranolol is evident by its ability to reverse the DMR signals of β2AR agonists such as isoprotenerol and epinephrine. An antagonism assay is also an example of a sequential stimulation assay as shown in FIG. 1G.

d) Co-Stimulation Assay

The co-stimulation assay or like terms refers to a one-step assay, wherein a cell is stimulated with a cocktail solution containing a molecule of interest and a referencing molecule. The referencing molecule can be a pathway modulator downstream to the receptor. An example is shown in FIG. 1C, wherein the referencing molecule is the adenylyl cyclase activator forskolin. Adenylyl cyclases are enzymes downstream to both G_{αs} and G_{αi} mediated signaling.

e) Reverse Sequential Stimulation Assays

The reverse sequential stimulation assay or like terms refers to a two step assay, wherein a cell is first stimulated with an agonist for a receptor, followed by stimulation with a molecule. The receptor agonist can be an endogenous agonist for the receptor. An example is shown in FIG. 1D, wherein the cells are sequentially stimulated with the β2AR agonist epinephrine, and the molecule salbutamol, respectively. In FIG. 1D, only the second step was monitored and shown. Epinephrine was presented in both steps.

f) Modulation Assay

The modulation assay or like term refers to a two step assay, wherein a cell is first stimulated with a referencing molecule, followed by stimulation with a molecule. The referencing molecule can be a pathway modulator, such as casein kinase 2 (CK2) inhibitor TBB, or a PI3K inhibitor LY294002, or a ROCK inhibitor Y27632, or a MEK inhibitor U0126, or toxin (e.g., pertussis toxin, cholera toxin) that disables corresponding G proteins G_{αi} and G_{αs}, respectively. An example is shown in FIG. 1E, wherein the A431 cells are first stimulated with the known casein kinase 2 inhibitor TBB for ˜1 hr, followed by stimulation with the molecule salbutamol. In FIG. 1E, only the second step was monitored and shown. The CK2 inhibitor TBB was presented in both steps. Another example is shown in FIG. 1F, wherein the A431 cells are first treated with the known G_{αi} protein killer pertussis toxin for overnight, followed by stimulation with the molecule salbutamol. In FIG. 1F the cells were preconditioned by overnight treatment with pertussis toxin.

g) Modulation Profiling Assay

The modulation profiling assay or like term refers to assaying a molecule to modulate a panel of markers in the same cell. Each marker is an activator of a specific cellular pathway or cellular process. An example is shown in FIG. 1H, wherein the A431 cells are first stimulated with the molecule salbutamol for about 1 hr, followed by stimulation individually with four different markers: the endogenous β2AR agonist epinephrine (Epi), the endogenous GPR109A agonist nicotinic acid (NA), the endogenous EGFR agonist EGF, and the endogenous H1R receptor agonist histamine (His). The modulation percentages against each maker are calculated based on the normalization of one or two specific DMR event of a marker DMR response in the presence of the molecule to the corresponding response in the absence of the molecule: the P-DMR event for the epinephrine DMR, the P-DMR event for the nicotinic acid DMR, the P-DMR and N-DMR events for the EGF DMR, and the P-DMR event for the histamine DMR. In FIG. 1H the markers are 2 nM epinephrine, 1 μM histamine, 32 nM epidermal growth factor, and 1 μM nicotinic acid. In all experiments, the concentration of salbutamol was 10 μM.

h) Numerical Matrices to Describe the Molecule DMR Signal Under Different Assay Conditions

Disclosed herein are methods to numerically describe any DMR signals under different conditions. The disclosed methods rely on the kinetics of cell signaling propagation, which often involves temporal and spatial dynamics and is regulated and gate kept by regulatory machineries such as phosphorylation. These assays are multiplexed in nature because label-free biosensor cellular assays measure an integrated and kinetic response of live cells upon stimulation. Also since different biosensor responses display different kinetics and dynamics, it is difficult to apply a simple strategy to determine the phases and amplitudes of biosensor events for a wide range of biosensor signals, particularly for a large scale screening data set. Thus, a simple numerical description number matrix would be desired.

Disclosed herein are methods using a panel of specific and predetermined time domain responses as the number matrix to describe any DMR signals. The panel of time domain responses can cover different waves of cell signaling from initial second messenger associated events, to intermediate signaling events (e.g., trafficking), and to cellular morphological changes. The number of time domain responses should be sufficient large enough to be representative but should be low enough such that it is practicable to carry out similarity analysis. In some embodiments, the numbers of time domain responses are in the range of 3 to 20. In some embodiments, the numbers of time domain responses are in the range of 3 to 15. In some embodiments, the numbers of time domain responses are in the range of 3 to 10. In some embodiments, the numbers of time domain responses are in the range of 3 to 7. In some embodiments, the numbers of time domain responses are in the range of 3 to 5. For example, the representative time domains can be chosen from different time periods, including 0-3 min, 3-6 min, 6-10 min, 10-20 min, 20-50 min, 50-120 min post stimulation. For β2AR on-target pharmacology analysis, the time domains can be 3, 5, 9, 15 and 50 min post-stimulation, meaning that the real signal at each time point is used to describe each DMR signal obtained under a specific assay condition. An example is that the numerical description for the salbutamol DMR signal under the sustained stimulation condition as shown in FIG. 1A is (−29, 7, 89, 155 and 199 picometers, at the time point of 3 min, 5 min, 9 min, 15 min and 50 min post stimulation). For RWG biosensors such as Epic system, the response is the measure of the shift in resonant wavelength of the biosensor system having the live cells upon stimulation.

i) Clustering Analysis

Disclosed herein are methods to classify the in vitro pharmacology of molecules acting on the same target receptor using clustering algorithm approaches. In some embodiments, the clustering algorithm approach can be one or two-dimensional.

In some embodiments, the clustering algorithms can be, but are not limited to, Hierarchical, K-means and MCL clustering. The Hierarchical clustering is a method of cluster analysis which seeks to build a hierarchy of clusters based on linkages (see Hastie, T., Tibshirani, R., Friedman, J. (2009). “14.3.12 Hierarchical clustering” in The Elements of Statistical Learning (2nd ed.). New York: Springer. pp. 520-528 and references cited therein). The K-Means clustering is a partitioning algorithm that divides the data into k non-overlapping clusters, wherein k is an input parameter, and also the number of clusters (see Hastie, T., Tibshirani, R., Friedman, J. (2009). The Elements of Statistical Learning (2nd ed.). New York: Springer. pp. 509-513 and references cited therein). One of the challenges in K-Means clustering is that the number of clusters must be chosen in advance, and in general are close to the square root of ½ of the number of nodes. Markov Clustering Algorithm (MCL) is a fast divisive clustering algorithm for graphs based on simulation of the flow in the graph. For label-free integrative pharmacology approach, Hierarchical clustering was used throughout the disclosed experimental examples described herein.

Clustering is a widely established technique for exploratory data analysis with applications in statistics, computer science, biology, social sciences, or psychology. It is applied to empirical data in basically any scientific field to gain an initial impression of structural similarities. For this purpose, it is of great advantage to have an efficient and easy-to-use tool that can be applied ubiquitously to a large scope of data types. However, the applications of clustering analysis in label-free cellular assays have not previously been explored.

The clustering analysis is generally carried out using conventional pairwise similarity functions to determine similarity (or distance) for each unordered pair in the dataset, leading to a similarity number matrix. The conventional pairwise similarity functions can be, but not limited to, Hierarchical, and k-Means. Both Hierarchical and K-means have been applied to cluster expression or genetic data. Hierarchical and k-Means clusters may be displayed as hierarchical groups of nodes or as heat maps. Other known methods, such as MCL and FORCE, can also be used. Both MCL and FORCE create collapsible “meta nodes” to allow interactive exploration of the putative family associations, and thus are often used for clustering similarity networks to look for protein families (and putative functional similarities).

Hierarchical clustering is a method of cluster analysis which seeks to build a hierarchy of clusters. Strategies for hierarchical clustering generally fall into two types: agglomerative and divisive. The agglomerative clustering is a “bottom up” approach—each observation starts in its own cluster, and pairs of clusters are merged as one moves up the hierarchy. The divisive clustering is a “top down” approach—all observations start in one cluster, and splits are performed recursively as one moves down the hierarchy. In order to decide which clusters should be combined (for agglomerative), or where a cluster should be split (for divisive), a measure of dissimilarity between sets of observations is required. In most methods of hierarchical clustering, this is achieved by use of an appropriate distance metric (a measure of distance between pairs of observations), and a linkage criteria which specifies the dissimilarity of sets as a function of the pairwise distances of observations in the sets. The choice of an appropriate metric will influence the shape of the clusters, as some elements may be close to one another according to one distance and farther away according to another. Common distance metrics include Euclidean distance, squared Euclidean distance, Manhattan distance, maximum distance, Mahalanobis distance, and cosine similarity. For example, the Euclidean distance can be used for label-free integrative pharmacology applications, and is used throughout in the disclosed experimental examples. Similarity and dissimilarity are two distance functions between two nodes. The similarity and dissimilarity is measured based on distance between the edge attributes of nodes.

Hierarchical clustering builds a dendrogram (binary tree) such that more similar nodes are likely to connect more closely into the tree. Hierarchical clustering is useful for organizing the data to get a sense of the pairwise relationships between data values and between clusters. The dendrogram is generated by using linkage criteria. The linkage is referred to a measure of “closeness” between the two groups. The linkage criteria determine the distance between sets of observations as a function of the pairwise distances between observations. There are four different types of linkage. In agglomerative clustering techniques such as hierarchical clustering, at each step in the algorithm, the two closest groups are chosen to be merged. The linkage methods include: (1) pairwise average-linkage (i.e., the mean distance between all pairs of elements in the two groups0, (2) pairwise single-linkage (i.e., the smallest distance between all pairs of elements in the two groups), (3) pairwise maximum-linkage (i.e., the largest distance between all pairs of elements in the two groups) and (4) pairwise centroid-linkage (i.e., the distance between the centroids of all pairs of elements in the two groups). For example, the pairwise maximum-linkage can be used for label-free integrative pharmacology applications.

For Hierarchical clustering, there are several ways to calculate the distance number matrix that is used to build the cluster. Typically, the distances represent the distances between two rows (usually representing nodes) in the number matrix. The distance metrics used can be, but not limited to, (1) Euclidean distance which is the simple two-dimensional Euclidean distance between two rows calculated as the square root of the sum of the squares of the differences between the values; (2) City-block distance which is the sum of the absolute value of the differences between the values in the two rows; (3) Pearson correlation which is the Pearson product-moment coefficient of the values in the two rows being compared. This value is calculated by dividing the covariance of the two rows by the product of their standard deviations; (4) Pearson correlation, absolute value which is similar to the value indicated in (3), but using the absolute value of the covariance of the two rows; (5) Uncentered correlation which is the standard Pearson correlation includes terms to center the sum of squares around zero. This metric makes no attempt to center the sum of squares. (6) Centered correlation, absolute value which is similar to the value indicated in (5), but using the absolute value of the covariance of the two rows; (7) Spearman's rank correlation which is Spearman's rank correlation (ρ) is a non-parametric measure of the correlation between the two rows; (8) Kendall's tau which ranks correlation coefficient (τ) between the two rows. The choice of distance metric for label-free integrative pharmacology is found to be dependent on the types of data. For example uncentered absolute correlation can be used for on-target pharmacology classification.

The similarity analysis can further use a predefined clustering threshold (a density parameter, also termed as similarity threshold) to compute a similarity number matrix. Such a threshold gives the boundary between similar and dissimilar objects, and thus is used to control the density of the clustering analysis. High (restrictive) values make it more expensive to add most of the edges, resulting in many small clusters. On the other hand, lower values make it cheap to add edges but expensive to remove them, resulting in few big clusters (meaning lower resolution). For label-free integrative pharmacology, the clustering threshold can be variable, and often depending on the desired resolution of clustering.

For label-free integrative pharmacology, the data contain the list of all numeric node and edge attributes that can be used for hierarchical clustering. The node can, for example, be the molecule. The edge attribute represents the response of the molecules either alone (i.e., a given response at a specific time i for the molecule primary profile in a cell), or represents the modulation percentage of the molecule against a marker (i.e., the modulation percentage of the marker biosensor response, such as P-DMR, or N-DMR, by the molecule at a specific concentration). At least one edge attribute or one or more node attributes must be selected to perform the clustering. If an edge attribute is selected, the resulting number matrix will be symmetric across the diagonal with nodes on both columns and rows. If multiple node attributes are selected, the attributes will define columns and the nodes will be the rows. Under certain circumstances, it can be desirable to cluster only a subset of the nodes in the network. For example, to identify molecules sharing a specific mode of action, only a subset of the nodes displaying such mode of action is examined.

For label-free integrative pharmacology approach, certain normalization or data pretreatments may be necessary for effectively clustering. For example, data filtering could be necessary. For similarity analysis based on molecule biosensor primary indices, an effective data filtering mean is to use the max-min difference (e.g., only molecules whose DMR signal having a max-min difference between different time points greater than 40 picometer within one hour post-stimulation are subject to similarity analysis).

For label-free on-target pharmacology studies, both one-dimensional and two-dimensional clustering analysis can be used. The one-dimensional clustering primarily is focused on the similarity among molecules (nodes). The two-way clustering, co-clustering or biclustering are clustering methods where not only the nodes (i.e., objects, molecules) are clustered but also the features (i.e., edge attributes) of the nodes, i.e., if the data is represented in a data matrix, the rows and columns are clustered simultaneously. The two dimensional clustering includes clustering both attributes and nodes. In such method, the clustering algorithm will be run twice, first with the rows in the number matrix representing the nodes and the columns representing the attributes. The resulting dendrogram provides a hierarchical clustering of the nodes given the values of the attributes. In the second pass, the number matrix is transposed and the rows represent the attribute values. This provides a dendrogram clustering the attributes. Both the node-based and the attribute-base dendrograms can be viewed. As shown in disclosed examples, the first clustering allows one to cluster molecules in term of their similarity and dissimilarity. The second clustering will serve different purposes, depending on the types of label-free integrative pharmacology analysis.

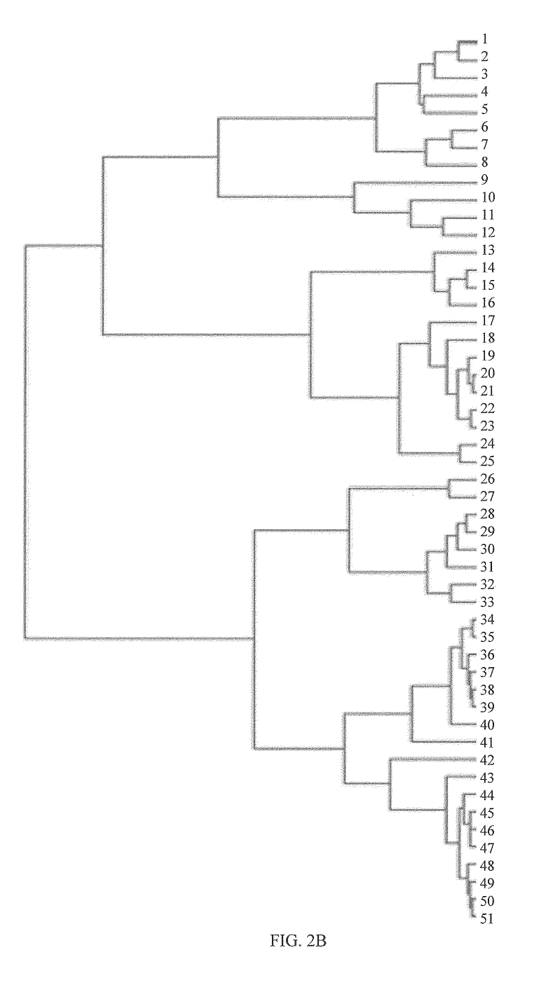

The similarity analysis typically leads to dendrogram which consists of interconnected or independent clusters of molecules, each cluster of molecules share similar mode(s) of action (i.e., pharmacology). The clusters can also be viewed as heat map. A heat map is a graphical representation of data where the values taken by a variable in a two-dimensional map are represented as colors. A very similar presentation form is a tree map. Heat maps originated in 2D displays of the values in a data matrix. Positive values are represented by red color squares and negative values by green color squares. Large values are displayed by darker color squares and smaller values by lighter color squares (exampled in FIG. 2). Cluster results are often permuted the rows and the columns of a matrix to place similar values near each other according to the clustering. Similarity analysis for gene expression analysis and protein network analysis has resulted in three types of popular heat map display, including HeatMapView (unclustered), Eisen TreeView, and Eisen KnnView. These heat map display approaches can be directly used to view the clusters and relations of molecules in terms of their label-free integrative pharmacology. Gene expression analysis often shows the results of hierarchically clustering of the nodes (i.e, genes) and a number of node attributes (typically expression data under different experimental conditions). Clustering based on label-free integrative pharmacology also displays the results of hierarchically clustering of the nodes (i.e., the molecules) and a number of node attributes. However, the note attributes used are dependent on the types of analysis. For on-target pharmacology classification, the node attributes can be the real value of a molecule biosensor signal/response at a number of time points post stimulation of cells with the molecule under different assay conditions. The node attributes can also be the modulation percentages of the molecule against each marker in the marker panel. The modulation percentage is often calculated by normalizing the marker biosensor response in the presence of a molecule to the marker biosensor response in the absence of the molecule. Such normalization is often based on signal amplitudes of a particular biosensor event (e.g., P-DMR, N-DMR or RP-DMR) but not the kinetics of the respective event, since it is the signal amplitude, but not the kinetics, that is associated with molecule efficacy (when the molecule is an agonist or activator for a pathway or a cellular process) or potency (when the molecule is an antagonist or inhibitor for a pathway or a cellular process).

Among the heat map display approaches developed to date, the Eisen TreeView is the most common approach. Here Hierarchical clustering results are usually displayed with a color-coded “Heat Map” of the data values and the dendrogram from clustering. Alternatively, when k-means clustering is used, the results can be shown with the Eisen KnnView.

### C. DEFINITIONS

1. A

As used in the specification and the appended claims, the singular forms “a,” “an” and “the” or like terms include plural referents unless the context clearly dictates otherwise. Thus, for example, reference to “an inhibitor” includes mixtures of two or more inhibitors, and the like.

2. Abbreviations

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, “M” for molar, and like abbreviations).

3. About

About modifying, for example, the quantity of an ingredient in a composition, concentrations, volumes, process temperature, process time, yields, flow rates, pressures, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging of a composition or formulation with a particular initial concentration or mixture, and amounts that differ due to mixing or processing a composition or formulation with a particular initial concentration or mixture. Whether modified by the term “about” the claims appended hereto include equivalents to these quantities.

4. “Across the Panel of Cells and Against the Panels of Markers”

The phrase “across the panel of cells and against the panels of markers” refers to a systematic process to examine the primary profiles of a molecule acting on each cell in the panel of cells, as well as the modulation profiles of the molecule to modulate the panels of markers. For a marker/cell pair, the process starts with first examining the primary profile of a molecule independently acting on each type of cells, followed by examining the secondary profile of a maker in the presence of the molecule in the same cell. The term “against” is specifically used to manifest the ability of the molecule to modulate the marker-induced biosensor response.

5. Agonist and Antagonist Mode

The agonism mode or like terms is the assay wherein the cells are exposed to a molecule to determine the ability of the molecule to trigger biosensor signals such as DMR signals, while the antagonism mode is the assay wherein the cells are exposed to a marker in the presence of a molecule to determine the ability of the molecule to modulate the biosensor signal of cells responding to the marker.

6. “Another Period of Time”

An “another period of time” or “extended period of time” or like terms is a period of time sequentially occurring after a period of time or after a treatment. The time period can vary greatly, from 10 min to 1 hr, 2 hrs, 4 hrs, 8 hrs, or 24 hrs.

7. A profile

A profile or like terms refers to the data which is collected for a composition, such as a cell. A profile can be collected from a label free biosensor as described herein.

8. A pulse stimulation assay

A “pulse stimulation assay” or like terms can used, wherein the cell is only exposed to a molecule for a very short of time (e.g., seconds, or several minutes). This pulse stimulation assay can be used to study the kinetics of the molecule acting on the cells/targets, as well as its impact on the marker-induced biosensor signals. The pulse stimulation assay can be carried out by simply replacing the molecule solution with the cell assay buffer solution by liquid handling device at a given time right after the molecule addition.

9. Assaying

Assaying, assay, or like terms refers to an analysis to determine a characteristic of a substance, such as a molecule or a cell, such as for example, the presence, absence, quantity, extent, kinetics, dynamics, or type of an a cell's optical or bioimpedance response upon stimulation with one or more exogenous stimuli, such as a ligand or marker. Producing a biosensor signal of a cell's response to a stimulus can be an assay.

10. Assay Format

An “assay format” or “assay formats” or the like terms refers to a particular type of assay, such as a sustained agonism stimulation assay, an antagonism assay, a sequential stimulation assay, a reverse sequential stimulation assay, a co-stimulation assay, modulation assay, and a modulation profiling assay.

11. Assaying the Response

“Assaying the response” or like terms means using a means to characterize the response. For example, if a molecule is brought into contact with a cell, a bio sensor can be used to assay the response of the cell upon exposure to the molecule.

12. Attach

“Attach,” “attachment,” “adhere,” “adhered,” “adherent,” “immobilized”, or like terms generally refer to immobilizing or fixing, for example, a surface modifier substance, a compatibilizer, a cell, a ligand candidate molecule, and like entities of the disclosure, to a surface, such as by physical absorption, chemical bonding, and like processes, or combinations thereof. Particularly, “cell attachment,” “cell adhesion,” or like terms refer to the interacting or binding of cells to a surface, such as by culturing, or interacting with cell anchoring materials, compatibilizer (e.g., fibronectin, collagen, lamin, gelatin, polylysine, etc.), or both. “Adherent cells,” “immobilized cells”, or like terms refer to a cell or a cell line or a cell system, such as a prokaryotic or eukaryotic cell, that remains associated with, immobilized on, or in certain contact with the outer surface of a substrate. Such types of cells after culturing can withstand or survive washing and medium exchanging processes staying adhered, a process that is prerequisite to many cell-based assays.

13. Biosensor

Biosensor or like terms refer to a device for the detection of an analyte that combines a biological component with a physicochemical detector component. The biosensor typically consists of three parts: a biological component or element (such as tissue, microorganism, pathogen, cells, or combinations thereof), a detector element (works in a physicochemical way such as optical, piezoelectric, electrochemical, thermometric, or magnetic), and a transducer associated with both components. The biological component or element can be, for example, a living cell, a pathogen, or combinations thereof. In embodiments, an optical biosensor can comprise an optical transducer for converting a molecular recognition or molecular stimulation event in a living cell, a pathogen, or combinations thereof into a quantifiable signal.

14. Biosensor Cellular Assay-Centered Cell Profile Pharmacology

A “biosensor cellular assay-centered cell profile pharmacology” or like terms is a method to determine the pharmacology of molecules using label-free biosensor cellular assays.

15. Biosensor Index

A “biosensor index” or like terms is an index made up of a collection of biosensor data. A biosensor index can be a collection of biosensor profiles, such as primary profiles, or secondary profiles. The index can be comprised of any type of data. For example, an index of profiles could be comprised of just an N-DMR data point, it could be a P-DMR data point, or both or it could be an impedence data point. It could be all of the data points associated with the profile curve.

16. Biosensor Response

A “biosensor response”, “biosensor output signal”, “biosensor signal” or like terms is any reaction of a sensor system having a cell to a cellular response. A biosensor converts a cellular response to a quantifiable sensor response. A biosensor response is an optical response upon stimulation as measured by an optical biosensor such as RWG or SPR or it is a bioimpedence response of the cells upon stimulation as measured by an electric biosensor. Since a biosensor response is directly associated with the cellular response upon stimulation, the biosensor response and the cellular response can be used interchangeably, in embodiments of disclosure.

17. Biosensor Signal

A “biosensor signal” or like terms refers to the signal of cells measured with a biosensor that is produced by the response of a cell upon stimulation.

18. Biosensor Surface

A biosensor surface or like words is any surface of a biosensor which can have a cell cultured on it. The biosensor surface can be tissue culture treated, or extracellular matrix material (e.g., fibronectin, laminin, collagen, or the like) coated, or synthetic material (e.g, poly-lysine) coated.

19. Cell

Cell or like term refers to a small usually microscopic mass of protoplasm bounded externally by a semipermeable membrane, optionally including one or more nuclei and various other organelles, capable alone or interacting with other like masses of performing all the fundamental functions of life, and forming the smallest structural unit of living matter capable of functioning independently including synthetic cell constructs, cell model systems, and like artificial cellular systems.

A cell can include different cell types, such as a cell associated with a specific disease, a type of cell from a specific origin, a type of cell associated with a specific target, or a type of cell associated with a specific physiological function. A cell can also be a native cell, an engineered cell, a transformed cell, an immortalized cell, a primary cell, an embryonic stem cell, an adult stem cell, an induced pluripotent stem, a cancer stem cell, or a stem cell derived cell. A cell system containing at least two types of cells can also be used. The cell system can be formed naturally or via co-culturing.

Human consists of about 210 known distinct cell types. The numbers of types of cells can almost unlimited, considering how the cells are prepared (e.g., engineered, transformed, immortalized, or freshly isolated from a human body) and where the cells are obtained (e.g., human bodies of different ages or different disease stages, etc).

20. Cell Biology Approaches

A “cell biology approach” or like terms is a scientific approach that involves studies cells—their physiological properties, their structure, the organelles they contain, interactions with their environment, their life cycle, division and death. This is done both on a microscopic and molecular level. Knowing the components of cells and how cells work is fundamental to all biological sciences.

21. Cell Culture

“Cell culture” or “cell culturing” refers to the process by which either prokaryotic or eukaryotic cells are grown under controlled conditions. “Cell culture” not only refers to the culturing of cells derived from multicellular eukaryotes, especially animal cells, but also the culturing of complex tissues and organs.

22. Cell Panel

A “cell panel” or like terms is a panel which comprises at least two types of cells. The cells can be of any type or combination disclosed herein.

23. Cellular Background

A “cellular background” or like terms is a type of cell having a specific state. For example, different types of cells have different cellular backgrounds (e.g., differential expression or organization of cellular receptors). A same type of cell but having different states also has different cellular backgrounds. The different states of the same type of cells can be achieved through culture (e.g., cell cycle arrested, or proliferating or quiescent states), or treatment (e.g., different pharmacological agent-treated cells).

24. Cellular Process

A cellular process or like terms is a process that takes place in or by a cell. Examples of cellular process include, but not limited to, proliferation, apoptosis, necrosis, differentiation, cell signal transduction, polarity change, migration, or transformation.

25. Cell Profile Pharmacology

The “cell profile pharmacology” or like terms uses a label-free biosensor, particularly an optical biosensor, to generate primary profiles of a cell in response to stimulation individually or collectively with a molecule, as well as secondary profiles of a cell in response to stimulation individually or collectively with panels of marker molecules in the absence of the molecule. The collection of both primary profile and the secondary profile, and their resulting modulation profiles is used, independently or collectively, to determine the pharmacology of the molecule.

26. Cellular Response

A “cellular response” or like terms is any reaction by the cell to a stimulation.

27. Cellular Target

A “cellular target” or like terms is a biopolymer such as a protein or nucleic acid whose activity can be modified by an external stimulus. Celluar targets are most commonly proteins such as enzymes, kinases, ion channels, and receptors.

28. Components

Disclosed are the components to be used to prepare the disclosed compositions as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these molecules may not be explicitly disclosed, each is specifically contemplated and described herein. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods.

29. Compounds and Compositions

Compounds and compositions have their standard meaning in the art. It is understood that wherever, a particular designation, such as a molecule, substance, marker, cell, or reagent compositions comprising, consisting of, and consisting essentially of these designations are disclosed. Thus, where the particular designation marker is used, it is understood that also disclosed would be compositions comprising that marker, consisting of that marker, or consisting essentially of that marker. Where appropriate wherever a particular designation is made, it is understood that the compound of that designation is also disclosed. For example, if particular biological material, such as a GPCR agonist, is disclosed, the GPCR agonist in its compound form is also disclosed.

30. Comprise

Throughout the description and claims of this specification, the word “comprise” and variations of the word, such as “comprising” and “comprises,” means “including but not limited to,” and is not intended to exclude, for example, other additives, components, integers or steps.

31. Consisting Essentially of

“Consisting essentially of” in embodiments refers to, for example, a surface composition, a method of making or using a surface composition, formulation, or composition on the surface of the biosensor, and articles, devices, or apparatus of the disclosure, and can include the components or steps listed in the claim, plus other components or steps that do not materially affect the basic and novel properties of the compositions, articles, apparatus, and methods of making and use of the disclosure, such as particular reactants, particular additives or ingredients, a particular agents, a particular cell or cell line, a particular surface modifier or condition, a particular ligand candidate, or like structure, material, or process variable selected. Items that may materially affect the basic properties of the components or steps of the disclosure or may impart undesirable characteristics to the present disclosure include, for example, decreased affinity of the cell for the biosensor surface, aberrant affinity of a stimulus for a cell surface receptor or for an intracellular receptor, anomalous or contrary cell activity in response to a ligand candidate or like stimulus, and like characteristics.

32. Characterizing

Characterizing or like terms refers to gathering information about any property of a substance, such as a ligand, molecule, marker, or cell, such as obtaining a profile for the ligand, molecule, marker, or cell.

33. Chemical Biology Approach

“chemical biology approach” or like terms is a scientific approach that involves the application of chemical techniques and tools, often compounds produced through synthetic chemistry, to the study and manipulation of biological systems. Some forms of chemical biology attempt to answer biological questions by directly probing living systems at the chemical level. In contrast to research using biochemistry, genetics, or molecular biology, where mutagenesis can provide a new version of the organism or cell of interest, chemical biology studies sometime probe systems in vitro and in vivo with small molecules that have been designed for a specific purpose or identified on the basis of biochemical or cell-based screening.

34. Contacting

Contacting or like terms means bringing into proximity such that a molecular interaction can take place, if a molecular interaction is possible between at least two things, such as molecules, cells, markers, at least a compound or composition, or at least two compositions, or any of these with an article(s) or with a machine. For example, contacting refers to bringing at least two compositions, molecules, articles, or things into contact, i.e. such that they are in proximity to mix or touch. For example, having a solution of composition A and cultured cell B and pouring solution of composition A over cultured cell B would be bringing solution of composition A in contact with cell culture B. Contacting a cell with a ligand would be bringing a ligand to the cell to ensure the cell have access to the ligand.

It is understood that anything disclosed herein can be brought into contact with anything else. For example, a cell can be brought into contact with a marker or a molecule, a biosensor, and so forth.

35. Control

The terms control or “control levels” or “control cells” or like terms are defined as the standard by which a change is measured, for example, the controls are not subjected to the experiment, but are instead subjected to a defined set of parameters, or the controls are based on pre- or post-treatment levels. They can either be run in parallel with or before or after a test run, or they can be a pre-determined standard. For example, a control can refer to the results from an experiment in which the subjects or objects or reagents etc are treated as in a parallel experiment except for omission of the procedure or agent or variable etc under test and which is used as a standard of comparison in judging experimental effects. Thus, the control can be used to determine the effects related to the procedure or agent or variable etc. For example, if the effect of a test molecule on a cell was in question, one could a) simply record the characteristics of the cell in the presence of the molecule, b) perform a and then also record the effects of adding a control molecule with a known activity or lack of activity, or a control composition (e.g., the assay buffer solution (the vehicle)) and then compare effects of the test molecule to the control. In certain circumstances once a control is performed the control can be used as a standard, in which the control experiment does not have to be performed again and in other circumstances the control experiment should be run in parallel each time a comparison will be made.

36. Defined Pathway(s)

A “defined pathway” or like terms is a specific pathway, such as G_{αg} pathway, G_{αs} pathway, G_{αi} pathway, G_{12/13}, EGFR (epidermal growth factor receptor) pathway, or PKC (protein kinase C) pathway.

37. Detect

Detect or like terms refer to an ability of the apparatus and methods of the disclosure to discover or sense a molecule-induced cellular response and to distinguish the sensed responses for distinct molecules.

38. Direct Action (of a Drug Candidate Molecule)

A “direct action” or like terms is a result (of a drug candidate molecule”) acting on a cell.

39. DMR Index

A “DMR index” or like terms is a biosensor index made up of a collection of DMR data.

40. DMR Response

A “DMR response” or like terms is a biosensor response using an optical biosensor. The DMR refers to dynamic mass redistribution or dynamic cellular matter redistribution. A P-DMR is a positive DMR response, a N-DMR is a negative DMR response, and a RP-DMR is a recovery P-DMR response.

41. DMR Signal

A “DMR signal” or like terms refers to the signal of cells measured with an optical biosensor that is produced by the response of a cell upon stimulation.

42. Drug Candidate Molecule

A drug candidate molecule or like terms is a test molecule which is being tested for its ability to function as a drug or a pharmacophore. This molecule may be considered as a lead molecule.

43. Early Culture

An early culture or like terms is the relative status of cells during a culture which is often related to its confluency or cell cycle states Early culture is cell culture towards high confluency, greater than or equal to 90%. Time less than or equal to the cell doubling time.

44. Efficacy

Efficacy or like terms is the capacity to produce a desired size of an effect under ideal or optimal conditions. It is these conditions that distinguish efficacy from the related concept of effectiveness, which relates to change under real-life conditions. Efficacy is the relationship between receptor occupancy and the ability to initiate a response at the molecular, cellular, tissue or system level.

45. High Confluency

Cell confluency or like terms refers to the coverage or proliferation that the cells are allowed over or throughout the culture medium. Since many types of cells can undergo cell contact inhibition, a high confluency means that the cells cultured reach high coverage (>90%) on a tissue culture surface or a biosensor surface, and have significant restriction to the growth of the cells in the medium. Conversely, a low confluency (e.g., a confluency of 40-60%) means that there may be little or no restriction to the growth of the cells in/on the medium and they can be assumed to be in a growth phase.

46. Higher and Inhibit and Like Words

The terms higher, increases, elevates, or elevation or like terms or variants of these terms, refer to increases above basal levels, e.g., as compared a control. The terms low, lower, reduces, decreases or reduction or like terms or variation of these terms, refer to decreases below basal levels, e.g., as compared to a control. For example, basal levels are normal in vivo levels prior to, or in the absence of, or addition of a molecule such as an agonist or antagonist to a cell. Inhibit or forms of inhibit or like terms refers to to reducing or suppressing.

47. “In the Presence of the Molecule”

“in the presence of the molecule” or like terms refers to the contact or exposure of the cultured cell with the molecule. The contact or exposure can take place before, or at the time, the stimulus is brought to contact with the cell.

48. Index

An index or like terms is a collection of data. For example, an index can be a list, table, file, or catalog that contains one or more modulation profiles. It is understood that an index can be produced from any combination of data. For example, a DMR profile can have a P-DMR, a N-DMR, and a RP-DMR. An index can be produced using the completed date of the profile, the P-DMR data, the N-DMR data, the RP-DMR data, or any point within these, or in combination of these or other data. The index is the collection of any such information. Typically, when comparing indexes, the indexes are of like data, i.e. P-DMR to P-DMR data.

49. “Indicator for the Mode of Action of the Molecule”

An “indicator” or like terms is a thing that indicates. Specifically, “an indicator for the mode of action of the molecule” means a thing, such as the similarity of biosensor index of a molecule in comparison with a biosensor index of a well-known modulator, that can be interpreted that the molecule and the well-known modulator share similar mode of action.

50. Kinetic Response of the Cells/Markers in the Absence and Presence of a Molecule

“kinetic response of the cells/markers in the absence and presence of a molecule” or like phrases refers to the entire assay or partial assay time series of cellular responses induced by a marker in the absence and presence of a molecule which can be directly used for examining the pharmacology or mode of action of the molecule, using, for example, pattern recognition analysis.

51. Known Modulator

A known modulator or like terms is a modulator where at least one of the targets is known with a known affinity. For example, a known modulator could be a β₂-andrenergic receptor agonist.

52. Known Modulator DMR Index

A “known modulator DMR index” or like terms is a modulator DMR index produced by data collected for a known modulator. For example, a known modulator DMR index can be made up of a profile of the known modulator acting on the panel of cells, and the modulation profile of the known modulator against the panels of markers, each panel of markers for a cell in the panel of cells.

53. Known Modulator Biosensor Index

A “known modulator biosensor index” or like terms is a modulator biosensor index produced by data collected for a known modulator. For example, a known modulator biosensor index can be made up of a profile of the known modulator acting on the panel of cells, and the modulation profile of the known modulator against the panels of markers, each panel of markers for a cell in the panel of cells.

54. Known Modulator DMR Index

A “known modulator DMR index” or like terms is a modulator DMR index produced by data collected for a known modulator. For example, a known modulator DMR index can be made up of a profile of the known modulator acting on the panel of cells, and the modulation profile of the known modulator against the panels of markers, each panel of markers for a cell in the panel of cells.

55. Known Molecule

A known molecule or like terms is a molecule with known pharmacological/biological/physiological/pathophysiological activity whose precise mode of action(s) may be known or unknown.

56. Library

A library or like terms is a collection. The library can be a collection of anything disclosed herein. For example, it can be a collection, of indexes, an index library; it can be a collection of profiles, a profile library; or it can be a collection of DMR indexes, a DMR index library; Also, it can be a collection of molecules, a molecule library; it can be a collection of cells, a cell library; it can be a collection of markers, a marker library; A library can be for example, random or non-random, determined or undetermined. For example, disclosed are libraries of DMR indexes or biosensor indexes of known modulators.

57. Ligand

A ligand or like terms is a substance or a composition or a molecule that is able to bind to and form a complex with a biomolecule to serve a biological purpose. Actual irreversible covalent binding between a ligand and its target molecule is rare in biological systems. Ligand binding to receptors alters the chemical conformation, i.e., the three dimensional shape of the receptor protein. The conformational state of a receptor protein determines the functional state of the receptor. The tendency or strength of binding is called affinity. Ligands include substrates, blockers, inhibitors, activators, and neurotransmitters. Radioligands are radioisotope labeled ligands, while fluorescent ligands are fluorescently tagged ligands; both can be considered as ligands are often used as tracers for receptor biology and biochemistry studies. Ligand and modulator are used interchangeably.

58. Long Term Assay

“Long term assay” or like terms is used for studying the long-term impact of a given molecule on a living cell. A particular type of long term assay is a “long-term biosensor cellular assay.” In one embodiment, each type of cell is exposed to the molecule only for a long period of time (e.g., 8 hrs, 16 hrs, 24 hrs, 32 hrs, 48 hrs, and 72 hrs). This long-term assay is used to determine the impact of the molecule on the cell healthy state (e.g., viability, apoptosis, cell cycle regulation, cell adhesion regulation, proliferation). Also this long-term assay contains early cell signaling response (e.g., 30 min, 60 min, 120 min, 180 min after molecule stimulation), which can be used directly to study the molecule-induced cell signaling events or pathways.

In another embodiment, a long-term biosensor cellular assay in the presence of a marker is used to study the cross regulation of the long-term impacts on cell biology and physiology between the molecule and the marker. The marker(s) can be added before, at, and after the molecule. For example, when a marker (e.g., H₂O₂) triggers the apoptosis of at least one type of cells in the cell panel, one can use such long-term assays to determine whether the molecule is protective or not. The reverse is also true that such long-terms assays can be used to determine the protective or synergistic role of a marker against a molecule-induced cellular event (e.g., apoptosis, or necrosis).

59. “Long-Term Biosensor Signal”

A “long term biosensor signal” is a biosensor signal produced from a long term assay.

60. “Long-Term DMR Signal”

A long term DMR signal or like terms is an optical biosensor signal produced from a long term optical biosensor cellular assay.

61. Low CO₂ Environment

A low CO₂ environment is an environment that has less than 4.5% CO₂.

62. Marker

A marker or like terms is a ligand which produces a signal in a biosensor cellular assay. The signal is, must also be, characteristic of at least one specific cell signaling pathway(s) and/or at least one specific cellular process(es) mediated through at least one specific target(s). The signal can be positive, or negative, or any combinations (e.g., oscillation).

63. Marker Biosensor Index

A “marker biosensor index” or like terms is a biosensor index produced by data collected for a marker. For example, a marker biosensor index can be made up of a profile of the marker acting on the panel of cells, and the modulation profile of the marker against the panels of markers, each panel of markers for a cell in the panel of cells.

64. Marker DMR Index

A “marker biosensor index” or like terms is a biosensor DMR index produced by data collected for a marker. For example, a marker DMR index can be made up of a profile of the marker acting on the panel of cells, and the modulation profile of the marker against the panels of markers, each panel of markers for a cell in the panel of cells.

65. Marker Panel

A “marker panel” or like terms is a panel which comprises at least two markers. The markers can be for different pathways, the same pathway, different targets, or even the same targets.

66. Material

Material is the tangible part of something (chemical, biochemical, biological, or mixed) that goes into the makeup of a physical object.

67. Number Matrix

A number matrix or like terms is something that can contain an array of mathematical elements (such as biosensor response data) that can be combined to form sums and products with similar arrays having an appropriate number of rows and columns or simply a rectangular arrangement of elements into rows and columns. The number matrix can have a considerable effect on the way the analysis is conducted and the quality of the results obtained. For example, in embodiments of the disclosure, the number matrix can be a panel of specific and predetermined time domain responses used to describe any DMR signals. Another example is a number matrix for selecting a panel of cell assays for characterizing molecules and includes, but is not limited to, for example, sustained agonism stimulation, sequential antagonism stimulation, reverse sequential stimulation, co-stimulation with a pathway modulator, and modulation of a panel of markers for distinct pathways. In again another embodiment, a mixed population of at least two types of assays can be used as a system.

Another example is a number matrix composed of selecting a panel of cells for characterizing molecules includes, but is not limited to, for example, a specific disease (e.g., panels of cells responsible for allergic reactions, or for inflammatory diseases, or for pathogenic infection, or for a breast cancer, or for a skin cancer, or for a colon cancer, or for a liver disease, or for a pancreatic cancer, or for a heart disease, etc), or for a specific origin (e.g., panels of neuronal cells, or lung cells, or skin cells, or muscle cells, or liver cells, etc), or for a specific cellular targets (e.g., a receptor, or an enzyme, or a kinase, or an oncogene, or a structural protein, or a DNA, or a RNA), or for a broad spectrum of types of cells representative to human physiology and pathophysiology (e.g., panels of cells consisting of a Keratinizing epithelial cell, a Wet stratified barrier epithelial cell, an exocrine secretory epithelial cell, a hormone secreting cell, a metabolism and storage cell, a barrier function cell (lung, gut, exocrine glands and urogenital tract), an epithelial cell lining closed internal body cavities, a ciliated cell with propulsive function, an extracellular number matrix secretion cell, a contractile cell, a blood and immune system cell, a sensory transducer cell, an autonomic neuron cell, a sense organ and peripheral neuron supporting cell, a central nervous system neurons and glial cell, a lens cell, a pigment cell, a germ cell, a nurse cell, and an interstitial cell). In again another embodiment, a mixed population of at least two types of cells can be used as a cell system, and can be used in a numerical matrix.

68. Medium

A medium is any mixture within which cells can be cultured. A growth medium is an object in which microorganisms or cells experience growth.

69. Mimic

As used herein, “mimic” or like terms refers to performing one or more of the functions of a reference object. For example, a molecule mimic performs one or more of the functions of a molecule.

70. Modulate

To modulate, or forms thereof, means either increasing, decreasing, or maintaining a cellular activity mediated through a cellular target. It is understood that wherever one of these words is used it is also disclosed that it could be 1%, 5%, 10%, 20%, 50%, 100%, 500%, or 1000% increased from a control, or it could be 1%, 5%, 10%, 20%, 50%, or 100% decreased from a control.

71. Modulate the DMR Signal

“Modulate the DMR signal or like terms is to cause changes of the DMR signal or profile of a cell in response to stimulation with a molecule.

72. Modulation Comparison

A “modulation comparison” or like terms is a result of normalizing a primary profile and a secondary profile.

73. Modulation Profile

A “modulation profile” or like terms is the comparison between a secondary profile of the marker in the presence of a molecule and the primary profile of the marker in the absence of any molecule. The comparison can be by, for example, subtracting the primary profile from secondary profile or subtracting the secondary profile from the primary profile or normalizing the secondary profile against the primary profile.

74. Modulator

A modulator or like terms is a molecule, such as a ligand, that controls the activity of a cellular target. It is a signal modulating molecule binding to a cellular target, such as a target protein.

75. Modulator Biosensor Index

A “modulator biosensor index” or like terms is a biosensor index produced by data collected for a modulator, such as DMR data. For example, a modulator biosensor index can be made up of a profile of the modulator acting on the panel of cells, and the modulation profile of the modulator against the panels of markers, each panel of markers for a cell in the panel of cells.

76. Modulate the Biosensor Signal of a Marker

“Modulate the biosensor signal or like terms is to cause changes of the biosensor signal or profile of a cell in response to stimulation with a marker.

77. Modulator DMR Index

A “modulator DMR index” or like terms is a DMR index produced by data collected for a modulator. For example, a modulator DMR index can be made up of a profile of the modulator acting on the panel of cells, and the modulation profile of the modulator against the panels of markers, each panel of markers for a cell in the panel of cells.

78. Molecule

As used herein, the terms “molecule” or like terms refers to a biological or biochemical or chemical entity that exists in the form of a chemical molecule or molecule with a definite molecular weight. A molecule or like terms is a chemical, biochemical or biological molecule, regardless of its size.

Many molecules are of the type referred to as organic molecules (molecules containing carbon atoms, among others, connected by covalent bonds), although some molecules do not contain carbon (including simple molecular gases such as molecular oxygen and more complex molecules such as some sulfur-based polymers). The general term “molecule” includes numerous descriptive classes or groups of molecules, such as proteins, nucleic acids, carbohydrates, steroids, organic pharmaceuticals, small molecule, receptors, antibodies, and lipids. When appropriate, one or more of these more descriptive terms (many of which, such as “protein,” themselves describe overlapping groups of molecules) will be used herein because of application of the method to a subgroup of molecules, without detracting from the intent to have such molecules be representative of both the general class “molecules” and the named subclass, such as proteins. Unless specifically indicated, the word “molecule” would include the specific molecule and salts thereof, such as pharmaceutically acceptable salts.

79. Molecule Biosensor Index

A “molecule biosensor index” or like terms is a biosensor index produced by data collected for a molecule. For example, a molecule biosensor index can be made up of a profile of the molecule acting on the panel of cells, and the modulation profile of the molecule against the panels of markers, each panel of markers for a cell in the panel of cells.

80. Molecule DMR Index

A “molecule DMR index” or like terms is a DMR index produced by data collected for a molecule. For example, a molecule biosensor index can be made up of a profile of the molecule acting on the panel of cells, and the modulation profile of the molecule against the panels of markers, each panel of markers for a cell in the panel of cells.

81. Molecule Index

A “molecule index” or like terms is an index related to the molecule.

82. Molecule Mixture

A molecule mixture or like terms is a mixture containing at least two molecules. The two molecules can be, but not limited to, structurally different (i.e., enantiomers), or compositionally different (e.g., protein isoforms, glycoform, or an antibody with different poly(ethylene glycol) (PEG) modifications), or structurally and compositionally different (e.g., unpurified natural extracts, or unpurified synthetic compounds).

83. Molecule Modulation Index

A “molecule modulation index” or like terms is an index to display the ability of the molecule to modulate the biosensor output signals of the panels of markers acting on the panel of cells. The modulation index is generated by normalizing a specific biosensor output signal parameter of a response of a cell upon stimulation with a marker in the presence of a molecule against that in the absence of any molecule.

84. Molecule-Treated Cell

A molecule-treated cell or like terms is a cell that has been exposed to a molecule.

85. Molecule Pharmacology

Molecule pharmacology or the like terms refers to the systems cell biology or systems cell pharmacology or mode(s) of action of a molecule acting on a cell. The molecule pharmacology is often characterized by, but not limited, toxicity, ability to influence specific cellular process(es) (e.g., proliferation, differentiation, reactive oxygen species signaling), or ability to modulate a specific cellular target (e.g, β₂AR, ADRB2, ADRA1A, ADRA1B, ADRA1D, ADRA2A, ADRA2B, ADRA2C, ADRB1, ADRB3, PI3K, PKA, PKC, PKG, JAK2, MAPK, MEK2, or actin).

86. Native Cell

A native cell is any cell that has not been genetically engineered. A native cell can be a primary cell, a immortalized cell, a transformed cell line, a stem cell, or a stem cell derived cell.

87. Network Interaction

A “network interaction” or like terms is an interaction between at least two specific signaling cascades or pathways. For example, the activation of bradykinin B2 receptor in A431 cells leads to at least dual signaling pathways: Gq and Gs pathways, wherein the two pathways can cross-regulated each other. Such cross-regulation is a type of network interaction. Another example is EGFR signaling in A431 cells, which involves complex multi-component signal transduction pathways. These pathways provide opportunities for feedback, signal amplification, and interactions inside one cell between multiple signals and signaling pathways, primarily through network interactions.

88. Normalizing

Normalizing or like terms means, adjusting data, or a profile, or a response, for example, to remove at least one common variable. For example, if two responses are generated, one for a marker acting a cell and one for a marker and molecule acting on the cell, normalizing would refer to the action of comparing the marker-induced response in the absence of the molecule and the response in the presence of the molecule, and removing the response due to the marker only, such that the normalized response would represent the response due to the modulation of the molecule against the marker. A modulation comparison is produced by normalizing a primary profile of the marker and a secondary profile of the marker in the presence of a molecule (modulation profile).

89. On-Target Pharmacology

The on-target pharmacology or like terms refers to the actions and their associated consequences in live cells or cell systems of a drug molecule acting on a specific target. A drug molecule binds to the target that may have different consequences in live cells or cell systems, or the same cell but under different conditions.

90. Optional

“Optional” or “optionally” or like terms means that the subsequently described event or circumstance can or cannot occur, and that the description includes instances where the event or circumstance occurs and instances where it does not. For example, the phrase “optionally the composition can comprise a combination” means that the composition may comprise a combination of different molecules or may not include a combination such that the description includes both the combination and the absence of the combination (i.e., individual members of the combination).

91. Or

The word “or” or like terms as used herein means any one member of a particular list and also includes any combination of members of that list.

92. Panel

A panel or like terms is a predetermined set of specimens (cells, assays or pathways). A panel can be produced from picking specimens from a library. In embodiments of the disclosure a panel can be a panel of assays.

93. pH Buffered Assay Solution

A pH buffered assay solution is any solution which has been buffered to have a physiological pH (typically pH of 7.1).

94. Panning

Panning or like terms refers to screening a cell or cells for the presence of one or more receptors or cellular targets.

95. “Predetermined Time Domain”

A “predetermined time domain” or “time domain” refers to specific times or time periods during an event, such as an assay. For example, as disclosed herein, the time domains for collecting data when a cell is exposed to a molecule can be 0-3 min, 3-6 min, 6-10 min, 10-20 min, 20-50 min, 50-120 min post stimulation. In another example, as disclosed herein, the time domains collecting data when a cell is exposed to a molecule can be 3, 5, 9, 15 and 50 min post-stimulation. Thus, there can be multiple time domains during an event. For example, as disclosed herein, there can be 3-20, 3-15, 3-10, 3-7 and 3-5 time domains during an event.

96. “Period of Time”

A “period of time” refers to any period representing a passage of time. For example, 1 second, 1 minute, 1 hour, 1 day, and 1 week are all periods of time.

97. Post-Stimulation

Post-stimulation or like terms refers to a time after the stimulation of a cell with a molecule in a cellular assay.

98. Positive Control

A “positive control” or like terms is a control that shows that the conditions for data collection can lead to data collection.

99. Potency

Potency or like terms is a measure of molecule activity expressed in terms of the amount required to produce an effect of given intensity. The potency is proportional to affinity and efficacy. Affinity is the ability of the drug molecule to bind to a receptor.

100. Potentiate

Potentiate, potentiated or like terms refers to an increase of a specific parameter of a biosensor response of a marker in a cell caused by a molecule. By comparing the primary profile of a marker with the secondary profile of the same marker in the same cell in the presence of a molecule, one can calculate the modulation of the marker-induced biosensor response of the cells by the molecule. A positive modulation means the molecule to cause increase in the biosensor signal induced by the marker.

101. Primary Profile

A “primary profile” or like terms refers to a biosensor response or biosensor output signal or profile which is produced when a molecule contacts a cell. Typically, the primary profile is obtained after normalization of initial cellular response to the net-zero biosensor signal (i.e., baseline)

102. Profile

A profile or like terms refers to the data which is collected for a composition, such as a cell. A profile can be collected from a label free biosensor as described herein.

103. Publications

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

104. Pulse Stimulation Assay

A “pulse stimulation assay” or like terms can used, wherein the cell is only exposed to a molecule for a very short of time (e.g., seconds, or several minutes). This pulse stimulation assay can be used to study the kinetics of the molecule acting on the cells/targets, as well as its impact on the marker-induced biosensor signals. The pulse stimulation assay can be carried out by simply replacing the molecule solution with the cell assay buffer solution by liquid handling device at a given time right after the molecule addition.

105. Quiescence

Quiescence or the like terms refers to a state of being quiet, still, at rest, dormant, inactive. Quiescence may refer to the G₀ phase of a cell in the cell cycle; or quiescence is the state of a cell when it is not dividing. Cellular quiescence is defined as reversible growth/proliferation arrest induced by diverse anti-mitogenic signals, e.g., mitogen (e.g., growth factor) withdrawal, contact inhibition, and loss of adhesion.

106. Ranges

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

107. Receptor

A receptor or like terms is a protein molecule embedded in either the plasma membrane or cytoplasm of a cell, to which a mobile signaling (or “signal”) molecule may attach. A molecule which binds to a receptor is called a “ligand,” and may be a peptide (such as a neurotransmitter), a hormone, a pharmaceutical drug, or a toxin, and when such binding occurs, the receptor goes into a conformational change which ordinarily initiates a cellular response. However, some ligands merely block receptors without inducing any response (e.g. antagonists). Ligand-induced changes in receptors result in physiological changes which constitute the biological activity of the ligands. For example, a receptor can be a β2-andrenergic receptor or alapha andrenergic receptor. In further example, the receptor can be a β₂AR, ADRB2, ADRA1A, ADRA1B, ADRA1D, ADRA2A, ADRA2B, ADRA2C, ADRB1 and ADRB3.

108. Referencing Molecule

A “referencing molecule” or “reference molecule” or the like term refers to a molecule used to determine the impact of a test molecule acting on a cell. Depending on assay formations, a referencing molecule can be different. For example, in an antagonism assay, the referencing molecule is an agonist for the target receptor that the test molecule interacts with. In an sequential stimulation assay, the referencing molecule can be an agonist, an antagonist, or an inverse agonist for the target receptor that the test molecule interacts with. In a co-stimulation assay, the referencing molecule can be a pathway modulator downstream to the receptor, such as the adenylyl cyclase activator forskolin. In a modulation assay the referencing molecule can be a pathway modulator, such as casein kinase 2 (CK2) inhibitor TBB, or a PI3K inhibitor LY294002, or a ROCK inhibitor Y27632, or a MEK inhibitor U0126, or toxin (e.g., pertussis toxin, cholera toxin)

109. “Representative of a Particular Human Physiology and Pathophysiology”

“representative” or like terms is to being an example or type of a certain class or kind of thing. For example, the cellular characteristics of human lung cancer cell line A549 is considered to be representative to physiology of human lung cancer; thus, A549 is used as a model cell line for studying cell biology and physiology of human lung cancers.

110. Response

A response or like terms is any reaction to any stimulation.

111. “Robust Biosensor Signal”

A “robust biosensor signal” is a biosensor signal whose amplitude(s) is significantly (such as 3×, 10×, 20×, 100×, or 1000×) above either the noise level, or the negative control response. The negative control response is often the biosensor response of cells after addition of the assay buffer solution (i.e., the vehicle). The noise level is the biosensor signal of cells without further addition of any solution. It is worth noting that the cells are always covered with a solution before addition of any solution.

112. “Robust DMR Signal”

A “robust DMR signal” or like terms is a DMR form of a “robust biosensor signal.”

113. Sample

By sample or like terms is meant an animal, a plant, a fungus, etc.; a natural product, a natural product extract, etc.; a tissue or organ from an animal; a cell (either within a subject, taken directly from a subject, or a cell maintained in culture or from a cultured cell line); a cell lysate (or lysate fraction) or cell extract; or a solution containing one or more molecules derived from a cell or cellular material (e.g. a polypeptide or nucleic acid), which is assayed as described herein. A sample may also be any body fluid or excretion (for example, but not limited to, blood, urine, stool, saliva, tears, bile) that contains cells or cell components.

114. Secondary Profile

A “secondary profile” or like terms is a biosensor response or biosensor output signal of cells in response to a marker in the presence of a molecule. A secondary profile can be used as an indicator of the ability of the molecule to modulate the marker-induced cellular response or biosensor response.

115. Serum Containing Medium

Serum containing medium or like words is any cell culture medium which contains serum (such as fetal bovine serum). Fetal bovine serum (or fetal calf serum) is the portion of plasma remaining after coagulation of blood, during which process the plasma protein fibrinogen is converted to fibrin and remains behind in the clot. Fetal Bovine serum comes from the blood drawn from the unborn bovine fetus via a closed system venipuncture at the abattoir. Fetal Bovine Serum (FBS) is the most widely used serum due to being low in antibodies and containing more growth factors, allowing for versatility in many different applications. FBS is used in the culturing of eukaryotic cells.

116. Serum Depleted Medium

A serum depleted medium is any cell culture medium that does not contain serum.

117. “Short Period of Time”

A “short period of time” or like terms is a time period that is typically between 1 and 30 minutes.

118. Short Term Assay

A “short term assay” or like terms is used for studying the short-term impact of a given molecule on a living cell. A particular type of short term assay is a “short-term biosensor cellular assay.” In one embodiment, each type of cell is exposed to the molecule only for a short period of time (e.g., 5 min, 10 min, 30 min, 45 min, 60 min, 90 min, 180 min, and 240 min). This short-term assay is often used for detecting early cell signaling response, which can be used directly to study the molecule-induced cell signaling events or pathways or to study the ability of the molecule to modulate a marker-induced cellular response.

119. Signaling Pathway(s)

A “defined pathway” or like terms is a path of a cell from receiving a signal (e.g., an exogenous ligand) to a cellular response (e.g., increased expression of a cellular target). In some cases, receptor activation caused by ligand binding to a receptor is directly coupled to the cell's response to the ligand. For example, the neurotransmitter GABA can activate a cell surface receptor that is part of an ion channel GABA binding to a GABA A receptor on a neuron opens a chloride-selective ion channel that is part of the receptor. GABA A receptor activation allows negatively charged chloride ions to move into the neuron which inhibits the ability of the neuron to produce action potentials. However, for many cell surface receptors, ligand-receptor interactions are not directly linked to the cell's response. The activated receptor must first interact with other proteins inside the cell before the ultimate physiological effect of the ligand on the cell's behavior is produced. Often, the behavior of a chain of several interacting cell proteins is altered following receptor activation. The entire set of cell changes induced by receptor activation is called a signal transduction mechanism or pathway. The signaling pathway can be either relatively simple or quite complicated.

120. Specific Period of Time

A “specific period of time” or the like terms refers to specified period of time between two events. For example, as disclosed herein, in a two-step assay, the cells are first exposed to a molecule, followed by stimulation with a receptor agonist. The two steps are separated by a specific period of time. For example, as disclosed herein, for label-free cellular assays, it can be ˜1 hr.

121. Starving the Cells

Starving the cells or like terms refers to a process to drive cells into quiescence during cell culture. The mitogen (e.g., serum or growth factors) withdrawl from the cell culture medium during the cell culture is the most common means to starving the cells. The mitogen withdrawl may be used in conjunction with other means (e.g., contact inhibition).

122. Substance

A substance or like terms is any physical object. A material is a substance. Molecules, ligands, markers, cells, proteins, and DNA can be considered substances. A machine or an article would be considered to be made of substances, rather than considered a substance themselves.

123. Synchronized Cells

Synchronized cells or the like terms refer to a population of cells wherein the majority of cells in a single well of a microtiter plate are in the same state (e.g., the same cell cycle (such as G₀ or G₂)). Synchronize(d) cells or the like term can also refer to the manipulation of the environment surrounding the cells or the conditions at which cells are grown which results in a population of cells wherein most cells are in the same stage of the cell cycle.

124. Stable

When used with respect to pharmaceutical compositions, the term “stable” or like terms is generally understood in the art as meaning less than a certain amount, usually 10%, loss of the active ingredient under specified storage conditions for a stated period of time. The time required for a composition to be considered stable is relative to the use of each product and is dictated by the commercial practicalities of producing the product, holding it for quality control and inspection, shipping it to a wholesaler or direct to a customer where it is held again in storage before its eventual use. Including a safety factor of a few months time, the minimum product life for pharmaceuticals is usually one year, and preferably more than 18 months. As used herein, the term “stable” references these market realities and the ability to store and transport the product at readily attainable environmental conditions such as refrigerated conditions, 2° C. to 8° C.

125. Subject

As used throughout, by a subject or like terms is meant an individual. Thus, the “subject” can include, for example, domesticated animals, such as cats, dogs, etc., livestock (e.g., cattle, horses, pigs, sheep, goats, etc.), laboratory animals (e.g., mouse, rabbit, rat, guinea pig, etc.) and mammals, non-human mammals, primates, non-human primates, rodents, birds, reptiles, amphibians, fish, and any other animal. In one aspect, the subject is a mammal such as a primate or a human. The subject can be a non-human.

126. Suspension Cells

“Suspension cells” refers to a cell or a cell line that is preferably cultured in a medium wherein the cells do not attach or adhere to the surface of a substrate during the culture. However, suspension cells can, in general, be brought to contact with the biosensor surface, by either chemical (e.g., covalent attachment, or antibody-cell surface receptor interactions), or physical means (e.g., settlement down, due to the gravity force, the bottom of a well wherein a biosensor is embedded). Thus, suspension cells can also be used for biosensor cellular assays.

127. Systems Biology

“Systems biology” or like terms is the ‘systematic’ interrogation of the biological processes within the complex, physiological milieu in which they function.

128. Systems Pharmacology

“Systems pharmacology” or like terms is using systems biology in the pursuit of a pharmacology goal.

129. Test Molecule

A test molecule or like terms is a molecule which is used in a method to gain some information about the test molecule. A test molecule can be an unknown or a known molecule.

130. Treating

Treating or treatment or like terms can be used in at least two ways. First, treating or treatment or like terms can refer to administration or action taken towards a subject, manipulating a subject. Second, treating or treatment or like terms can refer to mixing any two things together, such as any two or more substances together, such as a molecule and a cell. This mixing will bring the at least two substances together such that a contact between them can take place. For instance, “treating cell to reach high confluency”, means to take care or manipulate cells so they reach high confluency.

When treating or treatment or like terms is used in the context of a subject with a disease, it does not imply a cure or even a reduction of a symptom for example. When the term therapeutic or like terms is used in conjunction with treating or treatment or like terms, it means that the symptoms of the underlying disease are reduced, and/or that one or more of the underlying cellular, physiological, or biochemical causes or mechanisms causing the symptoms are reduced. It is understood that reduced, as used in this context, means relative to the state of the disease, including the molecular state of the disease, not just the physiological state of the disease.

131. Trigger

A trigger or like terms refers to the act of setting off or initiating an event, such as a response.

132. Two Step Assay

A “two-step assay” or like terms is used, while each type of the cells in the cell panel is exposed to a molecule first to study the molecule-induced biosensor signal, followed by a specific marker or a panel of markers to study the ability of the molecule to modulate the marker-induced biosensor signal(s). This assay can be referred to as a two-mode assay: such as the initial agonism mode and the subsequent antagonism mode, mode of actions (e.g., targets, agonism or antagonism, and potency or efficacy) of the molecule.

133. Ultra High Confluency

Ultra high confluency or the like terms refers to a population of cells that have at least 99% confluency in the end of cell culture.

134. Unknown Molecule

An unknown molecule or like terms is a molecule with unknown biological/pharmacological/physiological/pathophysiological activity.

135. Values

Specific and preferred values disclosed for components, ingredients, additives, cell types, markers, and like aspects, and ranges thereof, are for illustration only; they do not exclude other defined values or other values within defined ranges. The compositions, apparatus, and methods of the disclosure include those having any value or any combination of the values, specific values, more specific values, and preferred values described herein.

Thus, the disclosed methods, compositions, articles, and machines, can be combined in a manner to comprise, consist of, or consist essentially of, the various components, steps, molecules, and composition, and the like, discussed herein. They can be used, for example, in methods for characterizing a molecule including a ligand as defined herein; a method of producing an index as defined herein; or a method of drug discovery as defined herein.

136. Weakly Adherent Cells

“Weakly adherent cells” refers to a cell or a cell line or a cell system, such as a prokaryotic or eukaryotic cell, which weakly interacts, or associates or contacts with the surface of a substrate during cell culture. However, these types of cells, for example, human embryonic kidney (HEK) cells, dissociate from the surface of a substrate by the physically disturbing approach of washing or medium exchange.

137. Waves of Cell Signaling

“Waves of cell signaling” or the like terms refers to different stages of signaling and changes in a cell. For example, “waves of cell signaling” includes, but is not limited to, initial second messenger associated events, intermediate signaling events (e.g., trafficking), cellular morphological changes, de novo protein synthesis-associated events, or gene expression regulation and alteration associated events.

### D. EXAMPLES

1. Experimental Procedures

a) Reagents

All adrenergic receptor drugs were obtained from BIOMOL International, L.P. (Plymouth Meeting, Pa.). Epidermal growth factor (EGF) was obtained from BaChem Americas Inc. (Torrance, Calif.). Cell culture reagents were all purchased from GIBCO cell culture products. Epic® 384 biosensor microplates cell culture compatible were obtained from Corning Inc. (Corning, N.Y.).

b) Cell Culture

Human epidermoid carcinoma A431 cell line was purchased from American Type Cell Culture (ATCC) (Manassas, Va.) and maintained according to ATCC's instructions. The cell culture medium was Dulbecco's modified Eagle's medium (DMEM) supplemented with 10% fetal bovine serum (FBS), 4.5 g/liter glucose, 2 mM glutamine, and antibiotics.

Cells were typically grown using ˜1 to 2×10⁴ cells per well at passage 3 to 15 suspended in 50 μl of the corresponding culture medium in the biosensor microplate, and were cultured at 37° C. under air/5% CO₂ for ˜1 day. A431 cells were generally cultured one day in the serum medium, followed by starvation overnight in serum free medium. The confluency for all cells at the time of assays was ˜95% to 100%. The PTX treated A431 cells were obtained by treating one-day culture A431 cells with 100 ng/ml PTX for overnight.

c) Optical Biosensor System and Cell Assays

Epic® β version wavelength interrogation system (Corning Inc., Corning, N.Y.) was used for whole cell sensing. This system consists of a temperature-control unit, an optical detection unit, and an on-board liquid handling unit with robotics. The detection unit is centered on integrated fiber optics, and enables kinetic measures of cellular responses with a time interval of ˜15 sec.

The RWG biosensor is capable of detecting minute changes in local index of refraction near the sensor surface. Since the local index of refraction within a cell is a function of density and its distribution of biomass (e.g., proteins, molecular complexes), the biosensor exploits its evanescent wave to non-invasively detect ligand-induced dynamic mass redistribution in native cells. The evanescent wave extends into the cells and exponentially decays over distance, leading to a characteristic sensing volume of ˜150 nm, implying that any optical response mediated through the receptor activation only represents an average over the portion of the cell that the evanescent wave is sampling. The aggregation of many cellular events downstream the receptor activation determines the kinetics and amplitudes of a ligand-induced DMR.

For biosensor cellular assays, molecule solutions were made by diluting the stored concentrated solutions with the HBSS (1× Hanks balanced salt solution, plus 20 mM Hepes, pH 7.1), and transferred into a 384 well polypropylene molecule storage plate to prepare a molecule source plate. Both molecule and marker source plates were made separately when a two-step assay was performed. In parallel, the cells were washed twice with the HBSS and maintained in 30 μl of the HBSS to prepare a cell assay plate. Both the cell assay plate and the molecule and marker source plate(s) were then incubated in the hotel of the reader system. After ˜1 hr of incubation the baseline wavelengths of all biosensors in the cell assay microplate were recorded and normalized to zero. Afterwards, a 2 to 10 minute continuous recording was carried out to establish a baseline, and to ensure that the cells reached a steady state. Cellular responses were then triggered by pipetting 10 μl of the marker solutions into the cell assay plate using the on-board liquid handler.

To study the influence of molecules on a marker-induced response, a second stimulation with the marker at a fixed dose (typically at EC80 or EC100) was applied. The resonant wavelengths of all biosensors in the microplate were normalized again to establish a second baseline, right before the second stimulation. The two stimulations were usually separated by ˜1 hr.

All studies were carried out at a controlled temperature (28° C.). At least two independent sets of experiments, each with at least three replicates, were performed. The assay coefficient of variation was found to be <10%. A typical DMR signal of cells, as measured using Epic system, is a real time kinetic response which consists a baseline pre-stimulation (often normalized to zero), and a cellular response post stimulation.

### 2. Example 1

### Multiple Assays to Characterize the β2AR Agonist Salbutamol

A431 cells were used as a model system to fully characterize the on-target pharmacology of adrenergic receptor drug molecules. Gene expression analysis, using quantitative real time-PCR, found that A431 cells only express β2-adrenergic receptor (β2AR, ADRB2), but little or no any alpha adrenergic receptors (ADRA1A, ADRA1B, ADRA1D, ADRA2A, ADRA2B, ADRA2C) or other β adrenergic receptors (ADRB1, ADRB3) (data not shown).

In an agonism assay, 10 μM of Salbutamol resulted in a classical Gs-DMR signal in quiescent A431 cells, characterized by a rapid N-DMR followed by a slow P-DMR event (FIG. 1A). This shows that in A431 cells, salbutamol behaves as a strong agonist.

The pre-stimulation of A431 cells with salbutamol of 10 μM altered the propranolol DMR signal (FIG. 1B). Propranolol is a partial agonist for ERK pathway, and an inverse agonist for adenylyl cyclase-cAMP-PAK pathway. In the quiescent A431 cells, propranolol led to a detectable P-DMR signal. However, the salbutamol-treated A431 cells responded to propranolol with a N-DMR signal. This shows that propranolol can reverse the salbutamol-induced P-DMR signal. The propranolol concentration was 10 μM for both measurements.

The co-stimulation of quiescent A431 cells with forskolin (10 μM) and salbutamol (10 μM) led to a DMR signal that is different from the forskolin DMR signal—the co-stimulation gave rise to a greater N-DMR, and a smaller P-DMR with a slower kinetics (FIG. 1C). Forskolin is a well-known adenylyl cyclase activator, and at 10 μM it can fully activate Gs pathway in A431 cells. This shows that salbutamol triggers the activation of compensatory pathway(s) (e.g., ERK) to cap the forskolin mediated Gs signaling pathway.

The 10 nM epinephrine-pretreated A431 cells still responded to salbutamol, but with a much smaller response, compared to the untreated A431 cells (FIG. 1D). This shows that once the cells become fully activated by epinephrine via the endogenous β2AR, salbutamol acts as a strong partial agonist and still is able to slightly reverse the epinephrine response.

The CK2 inhibitor TBB pretreated cells greatly altered the salbutamol DMR signal—in the 10 μM TBB-treated cells, the salbutamol DMR signal lacks the initial N-DMR event and only consists of a suppressed P-DMR event (FIG. 1E). This shows that CK2 kinase is a downstream cascade of the β2AR signaling in A431, and plays a dominant role in the N-DMR event, and also contributes to the P-DMR event of the salbutamol DMR signal.

The 100 ng/ml PTX-treated A431 cells responded to salbutamol with a DMR signal that is similar to the control cells, but with accelerated P-DMR event (FIG. 1F). This shows that the preconditioning of A431 with PTX alters the cellular background, and results in the alteration in the β2AR signaling.

The pre-stimulation of A431 with 10 μM of salbutamol desensitize the cells to the second stimulation of 10 nM of epinephrine (FIG. 1G). This result reconfirms that salbutamol acts as a strong agonist for β2AR.

The modulation index of salbutamol against 4 different markers is shown in FIG. 1H. This result shows that the pretreatment of cells with 10 μM of salbutamol completely suppresses the epinephrine DMR, potentiates the Gi-coupled GPR109A agonist nicotinic acid DMR, has little impact on the EGFR agonist EGF DMR, and partially attenuates the Gq-coupled H1R agonist histamine DMR. This is expected since β2AR can undergo homologous desensitization, the activation of β2AR causes the increase in intracellular cAMP level which in turn potentiates Gi-mediated signaling (i.e., heterologous sensitization), and the activation of β2AR also cross-talks with the Gq-mediated pathway that suppresses the Gq signaling.

### 3. Example 2

### Label-Free on-Target Pharmacology Characterization of Adrenergic Receptor Drugs

To explore the potential of label-free on-target pharmacology approaches, known adrenergic receptor drugs are used. Table 1 contains all known adrenergic receptor drugs on the market today, and their corresponding therapeutic indications. All, except tamsulosin, are commercially available and tested using the disclosed methods. The main results are summarized in the heat map shown in FIG. 2.

TABLE 1
Marketed adrenergic receptor drugs, their targets and indications

| Generic Name | Indication | Target |
|---|---|---|
| Fenoterol | For the treatment of asthma. | β2 adrenergic receptor |
| Procaterol | For the treatment of asthma and chronic obstructive | β2 adrenergic receptor |
| | pulmonary disease (COPD). | |
| Clenbuterol | Used as a bronchodilator in the treatment of asthma | β2 adrenergic receptor |
| | patients. | |
| Formoterol | For use as long-term maintenance treatment of asthma in | β2 adrenergic receptor |
| | patients with reversible obstructive airways disease, | |
| | including patients with symptoms of nocturnal asthma. | |
| Arformoterol, | For the long term, twice daily maintenance treatment of | β2 adrenergic receptor |
| (R,R)- | bronchoconstriction in patients with chronic obstructive | |
| formoterol | pulmonary disease (COPD), including chronic bronchitis | |
| | and emphysema. | |
| Isoetharine | For the treatment of asthma, wheezing, and chronic | β1 adrenergic receptor |
| | asthmatic bronchitis. | |
| Isoproterenol | For the treatment of mild or transient episodes of heart | β1, β2 adrenergic |
| | block that do not require electric shock or pacemaker | receptor |
| | therapy also used in management of asthma and chronic | |
| | bronchitis. | |
| Salbutamol | For relief and prevention of bronchospasm due to asthma, | β2 adrenergic receptor |
| (albuterol) | emphysema, and chronic bronchitis. | |
| Terbutaline | For the prevention and reversal of bronchospasm in patients | β2 adrenergic receptor |
| | 12 years of age and older with asthma and reversible | |
| | bronchospasm associated with bronchitis and emphysema. | |
| Salmeterol | For the treatment of asthma and chronic obstructive | β2 adrenergic receptor |
| | pulmonary disease (COPD). | |
| Practolol | Used in the emergency treatment of cardiac arhyhmias. | β1, β2 adrenergic |
| | | receptor |
| Dobutamine | For inotropic support in the short-term treatment of patients | β1 adrenergic receptor |
| | with cardiac decompensation due to depressed contractility | |
| | resulting either from organic heart disease or from cardiac | |
| | surgical procedures. | |
| Dopamine | For the correction of hemodynamic imbalances present in | β1 adrenergic receptor |
| | the shock syndrome due to myocardial infarction, trauma, | |
| | endotoxic septicemia, open-heart surgery, renal failure, and | |
| | chronic cardiac decompensation as in congestive failure | |
| Isoproterenol | For the treatment of mild or transient episodes of heart | β1, β-2 adrenergic |
| | block that do not require electric shock or pacemaker | receptor |
| | therapy also used in management of asthma and chronic | |
| | bronchitis. | |
| Carvedilol | For the treatment of mild or moderate (NYHA class II or | β1, β-2, alpha-1A |
| | III) heart failure of ischemic or cardiomyopathic origin. | adrenergic receptor |
| Bxolol | For the management of hypertension. | β1 adrenergic receptor |
| Timolol | In its oral form it is used to treat high blood pressure and | β1, β-2 adrenergic |
| | prevent heart attacks, and occasionally to prevent migraine | receptor |
| | headaches. In its opthalmic form it is used to treat open- | |
| | angle and occasionally secondary glaucoma. | |
| Phenoxy- | For the treatment of phaeochromocytoma (malignant), | Alpha-1A adrenergic |
| benzamine | benign prostatic hypertrophy and malignant essential | receptor |
| | hypertension. | |
| Clonidine | For the treatment of hypertension and maybe used in | Alpha-2A adrenergic |
| | prophylaxis of migraine or recurrent vascular headache; | receptor |
| | Menopausal flushing | |
| Acebutolol | For the management of hypertension and ventricular | β1 adrenergic receptor |
| | premature beats in adults. | |
| Guanfacine | For use in the management of hypertension. | Alpha-1B, alpha-2A |
| | | adrenergic receptor |
| Labetalol | For the management of hypertension. | β1, β2, alpha-1A, alpha- |
| | | 1B-adrenergic receptor |
| Phentolamine | For the prevention or treatment of dermal necrosis and | Alpha-2A adrenergic |
| | sloughing following intravenous administration or | receptor |
| | extravasation of norepinephrine. Also for the prevention or | |
| | control of hypertensive episodes that may occur in a patient | |
| | with pheochromocytoma. | |
| Metoprolol | For the treatment of hypertension and angina pectoris. | β1 adrenergic receptor |
| Atenolol | For the management of hypertention and long-term | β1 adrenergic receptor |
| | management of patients with angina pectoris. | |
| Nadolol | Used in cardiovascular disease to treat arrhythmias, angina | β-1, β-2 adrenergic |
| | pectoris, and hypertension. | receptor |
| Alprenolol | For the treatment of hypertension, angina, and arrhythmia | β1, β-2 adrenergic |
| | | receptor |
| Oxprenolol | Used in the treatment of hypertension, angina pectoris, | β-1 adrenergic receptor; |
| | arrhythmias, and anxiety. | β-2 adrenergic receptor |
| Bisoprolol | For the management of hypertension and prophylaxis | β-1, β-2 adrenergic |
| | treatment of angina pectoris and heart failure. | receptor |
| Prazosin | For treatment of hypertension and chronic heart failure. | Alpha-1A, alpha-1 B, |
| | | alpha-1 D adrenergic |
| | | receptor |
| Pindolol | For the management of hypertension, edema, ventricular | β-1, β-2, β-3 adrenergic |
| | tachycardias, and atrial fibrillation. | receptor |
| Nicergoline | For the treatment of senile dementia, migraines of vascular | Alpha-1A adrenergic |
| | origin, transient ischemia, platelet hyper-aggregability, and | receptor |
| | macular degeneration. | |
| Propranolol | For the prophylaxis of migraine. | β-1, β-2, β-3 adrenergic |
| | | receptor |
| Oxymetazoline | For treatment of nasal congestion and redness associated | Alpha-1A, alpha-2A |
| | with minor irritations of the eye. | adrenergic receptor |
| Phenylephrine | For the treatment of ophthalmic disorders (hyperaemia of | Alpha-1A, alpha-1B |
| | conjunctiva, posterior synechiae, acute atopic), nasal | adrenergic receptor |
| | congestion, hemorrhoids, hypotension, shock, hypotension | |
| | during spinal anesthesia, paroxysmal supraventricular | |
| | tachycardia. | |
| Ritodrine | For the treatment and prophylaxis of premature labor | β-2 adrenergic receptor |
| Tamsulosin | Used in the treatment of signs and symptoms of benign | Alpha-1A, alpha-1B, |
| | prostatic hyperplasia. | alpha-1D adrenergic |
| | | receptor |
| Yohimbine | Indicated as a sympatholytic and mydriatic. Impotence has | Alpha-2A, 2B, 2C |
| | been successfully treated with yohimbine in male patients | adrenergic receptor |
| | with vascular or diabetic origins and psychogenic origins | |
| Epinephrine | Used to treat anaphylaxis and sepsis. | β-1, β-2, alpha-1A |
| | | adrenergic receptor |
| Norepinephrine | Mainly used to treat patients in vasodilatory shock states | β-1, β-2, β-3, alpha-2A, |
| | such as septic shock and neurogenic shock and has shown a | alpha-2B, alpha-2C, |
| | survival benefit over dopamine. Also used as a vasopressor | alpha-1A, alpha-1B, |
| | medication for patients with critical hypotension | alpha-1D adrenergic |
| | | receptor |
| Guanabenz | For management of high blood pressure | Alpha-2 adrenergic |
| | | receptor |
| Modafinil | To improve wakefulness in patients with excessive daytime | Alpha 1B-adrenergic |
| | sleepiness (EDS) associated with narcolepsy. | |
| Naphazoline | Go-drug with anti-histamine | alpha adrenergic receptor |
| Sotalol | For the maintenance of normal sinus rhythm [delay in time | β-1, β-2 adrenergic |
| | to recurrence of atrial fibrillation/atrial flutter (AFIB/AFL)] | receptor |
| | in patients with symptomatic AFIB/AFL who are currently | |
| | in sinus rhythm. Also for the treatment of documented life- | |
| | threatening ventricular arrhythmias. | |
| Tizanidine | For the management of increased muscle tone associated | Alpha-2 adrenergic |
| | with spasticity | receptor |
| Methylnorepi- | Active motabolite of Methyldopa which is used for the | Alpha-adrenergic |
| nephrine | treatment of hypertension | receptors |

As shown in FIG. 2, the classification of in vitro on-target pharmacology of adrenergic receptor drugs, particularly the β-adrenergic receptor drugs, closely resemble their in-vivo pharmacology. The first class consists of procaterol, clenbuterol, isoproterenol, formoterol, fenoterol, salbutamol (albuterol), and isoetharine, all of which are used for management of asthma. Forskolin, the adenylyl cyclase activator, is used as a control, and also similar to this family of drugs. This shows that these drugs act as agonists for the β2AR. Interestingly, the long-acting β agonist salmeterol is also similar to this family of drugs. Salmeterol is also used for management of asthema.

The second family of cluster drugs includes dobutamine and dopamine, both of which are used for treatment of heart diseases. This family also contains methylnorepinephrine, epinephrine, phenylephrine, norepinephrine, ritodrine and terbutaline.

The third family of cluster drugs includes pindolol, alprenolol, labetalol, acebutolol and cloninde, all of which are used for management of hypertension.

The fourth family of cluster drugs which is similar to the third family includes naphazoline and modafinil. Modafinil is used for treatment of excessive daytime sleepiness associated with narcolepsy. Naphazoline is used as a co-drug for anti-allergic agent. It is known that many anti-histamine anti-allergic drugs have common side effects—sleepiness.

The fifth family consists of oxprenolol, sotalol, nadolol, bisoprolol, metoprolol, timolol, βxolol, and atenolol. All, except of sotalol which is used for treatment of ventricular arrhytmias, are used for management of hypertension.

The sixth family consists of propranolol and carvedilol. Propranolol is used for migraine, while carvedilol is used for treatment of heart disease.

The other two families of drug clusters are alpha adrenergic receptor drugs.

The disclosed label-free on-target pharmacology approach allows appropriate classification of existing adrenergic receptor drugs, and the in vitro pharmacology obtained using this method is closely associated with their in vivo pharmacology. The disclosed label-free on-target pharmacology approach is powerful for drug repositioning and novel drug combinations. The similarity between naphazoline and modafinil suggests that naphazoline may be also useful for treatment of excessive daytime sleepiness associated with narcolepsy, or conversely, modafinil may be useful as a co-drug with anti-histamines. In addition, the similarity between terbutaline and ritodrine suggests that the anti-asthma drug terbutaline may be also useful for the treatment and prophylaxis of premature labor. Drug repositioning can increase productivity since the repositioned drug has already passed a significant number of toxicity and other tests, its safety is known and the risk of failure for reasons of adverse toxicology are reduced. More than 90% of drugs fail during development, and this is the most significant reason for the high costs of pharmaceutical R&D. In addition, repurposed drugs can bypass much of the early cost and time needed to bring a drug to market.

### REFERENCES

M. B. Eisen, P. T. Spellman, P. O. Brown, and David Botstein: Cluster analysis and display of genome-wide expression patterns. PNAS, 95(25):14863-8 (1998)

1. A method of determining the on-target pharmacology of a molecule comprising the steps:
a. collecting biosensor responses from a panel of assay formats;
b. analyzing the biosensor responses; and
c. determining the on-target pharmacology of the molecule.

2. The method of claim 1, wherein the biosensor response is a label-free biosensor response.

3. The method of claim 1, wherein the panel consists of two to ten assay formats.

4. The method of claim 1, wherein the assay formats are selected from a sustained agonism stimulation assay, an antagonism assay, a sequential stimulation assay, a reverse sequential stimulation assay, a co-stimulation assay, modulation assay, and a modulation profiling assay.

5. The method of claim 1, wherein the assay formats are selected from a sustained agonism stimulation assay, a sequential antagonism stimulation assay, a reverse sequential stimulation assay, a co-stimulation with a pathway modulator, and modulation of a panel of markers for distinct pathways.

6. The method of claim 1, wherein one or more of the assays collects data from a predetermined time domain.

7. The method of claim 6, wherein there are 3-20, 3-15, 3-10, 3-7 or 3-5 time domain responses.

8. The method of claim 6, wherein the time domain responses are taken 0-3 minutes, 3-6 minutes, 6-10 minutes, 10-20 minutes, 20-50 minutes and 50-120 minutes post-stimulation.

9. The method of claim 6, wherein the time domain responses covers different waves of cell signaling.

10. The method of claim 6, wherein the time domain responses are taken 3, 5, 9, 15 and 50 min post-stimulation.

11. The method of claim 6, wherein analyzing the biosensor response comprises, numerically describing DMR signals.

12. The method of claim 11, further comprising ordering the numerically described DMR signals into a number matrix.

13. The method of claim 12, wherein the number matrix is produced by performing a clustering algorithm analysis.

14. The method of claim 13, wherein the clustering algorithm analysis is one or two-dimensional.

15. The method of claim 13, wherein the clustering algorithm is Hierarchical, K-means or Markov clustering algorithm.

16. The method of claim 13, wherein the clustering algorithm is Hierarchical.

17. The method of claim 13, wherein the Hierarchical links groups using pairwise maximum linkage.

18. The method of claim 13, wherein the clustering algorithm uses Euclidean distance for its metrics.

19. The method of claim 13, wherein the clusters are viewed as a heat map.

20. A method of repositioning a test molecule comprising the steps:
a. collecting biosensor responses of the test molecule from a panel of assay formats;
b. analyzing the biosensor responses of the test molecule;
c. determining the on-target pharmacology of the test molecule;
d. clustering the drug molecule with existing drug molecules acting on the same target to identify the closest match in the on-target pharmacology of drug molecules; and
e. repositioning the test molecule for the indication of the closest matched drug molecules.
